(19) United States
(12) Patent Application Publication
(10) Pub. No.: US 2019/0335167 A1
(43) Pub. Date: Oct. 31, 2019

(54) METHOD AND APPARATUS FOR TIME-BASED STEREO DISPLAY OF IMAGES AND VIDEO

(71) Applicant: Sina Fateh, Sunnyvale, CA (US)

(72) Inventor: Sina Fateh, Sunnyvale, CA (US)

(21) Appl. No.: 16/389,206

(22) Filed: Apr. 19, 2019

Related U.S. Application Data
(60) Provisional application No. 62/662,221, filed on Apr. 25, 2018.

(51) Int. Cl. H04N 13/398; H04N 13/344; H04N 13/359; H04N 13/327

(52) U.S. Cl. CPC H04N 13/398; H04N 13/327; H04N 13/359; H04N 13/344

(57) ABSTRACT

An appearance of depth is provided by displaying a single-perspective video to the left and right eyes of a viewer, with a time offset therebetween. Objects moving relative to the background exhibit a spatial displacement between left and right eyes due to the time offset. Providing the video with that spatial displacement yields a parallax between left and right eyes for the moving objects, providing depth cues to the viewer. These depth cues are based on differences in time (two asynchronous views of the same scene), as distinct from stereo based on differences in space (two simultaneous views from different perspectives). However, “temporal stereo” may be visually fused by viewers similarly to spatial stereo, without requiring special training or effort. Also, even if depth cues are not comprehensive, continuous, and/or spatially accurate, the depth cues still may suggest depth within the scene.

### CROSS REFERENCE TO RELATED APPLICATIONS

This application claims priority to U.S. Provisional Application Ser. No. 62/662,221 filed Apr. 25, 2018, entitled “METHOD AND APPARATUS FOR TIME-BASED STEREO DISPLAY OF IMAGES AND VIDEO”, which is incorporated by reference herein in its entirety.

### FIELD OF THE INVENTION

Various embodiments concern the presentation of images and video with an appearance of stereo depth. More particularly, various embodiments relate to displaying a mono feed in such way that the same or a similar feed is viewable by both eyes of a viewer, with a time offset between the feed as viewed by the left and right eyes, so as to produce an appearance of stereo imagery to the viewer while utilizing only a single image or stream of images rather than two images or streams of images from two different perspectives.

### BACKGROUND

The display of stereo graphical content may be made to rely upon a spatial baseline. That is, two images or videos may be taken from slightly different positions, e.g., left and right video streams. The left stream is presented to the left eye of the viewer, and the right stream to the right eye. The viewer then fuses the two streams into a single view with an appearance of depth. This takes advantage of the nature of human vision, wherein two such views from different points in space (at the left and right eyes) are fused together in the viewer's brain to provide depth perception.

However, such an arrangement may present significant problems.

For example, if two video feeds are required, two video feeds must be obtained. In terms of hardware, this may require two cameras, a single camera with two optical paths, etc. in order to capture the two feeds. Among other concerns, this may increase the weight, power use, physical complexity, etc. of the camera system. As operational considerations, maintaining a fixed and appropriate stereo separation between cameras, managing increased weight and bulk, maintaining proper alignment of both cameras, keeping both systems operating at the same settings (e.g., ISO), etc. may prove problematic. For data processing, it may be necessary or at least highly desirable to synchronize the two streams with regard to focus, frame rate, resolution, etc. to compensate for differences between cameras, lenses, filters, etc. Even for two cameras that are nominally identical, variations in factors such as color intensity may occur due to slight variations in the imaging chips, etc.; it may be necessary or desirable to synchronize such factors as well. (For example, if the left eye perceives a given object as being “more green” than does the right, this may interfere with the appearance of depth.) In addition, other factors being equal the use of two video streams may be anticipated to approximately double the requirements for storing, processing, transmitting, and/or displaying data. This may present challenges in terms of storage capacity, processing power, bandwidth, etc.

Furthermore, considerable graphical content may exist that was not originally captured with two stereo views. For content wherein only a single mono feed exists, acquiring or reconstructing a second view after the fact may be impractical. For example, acquiring a second view of a wedding ten years in the past, a historical event that happened decades ago, or even a recent theatrical movie not shot in stereo, may be severely problematic.

### BRIEF DESCRIPTION OF THE SEVERAL VIEWS OF THE DRAWINGS

Various objects, features, and characteristics will become more apparent to those skilled in the art from a study of the following Detailed Description in conjunction with the appended claims and drawings, all of which form a part of this specification. While the accompanying drawings include illustrations of various embodiments, the drawings are not intended to limit the claimed subject matter.

Like reference numbers generally indicate corresponding elements in the figures.

FIG. 1 shows an example illustration of human stereo vision of objects at different distances, in top-down perspective.

FIG. 2 shows example views of an arrangement of objects similar to that in FIG. 1, from left and right perspectives.

FIG. 3 shows a sequence of images approximating frames from a video feed showing horizontal motion over time, along with a sequence of left and right feeds exhibiting an offset therebetween.

FIG. 4 shows a sequence of images approximating frames from a video feed showing vertical motion over time, along with a sequence of left and right feeds exhibiting an offset therebetween as may enable temporal stereo.

FIG. 5 shows a sequence of images approximating frames from a video feed showing diagonal motion over time, along with a sequence of left and right feeds exhibiting an offset therebetween as may enable temporal stereo.

FIG. 6 shows a sequence of images approximating frames from a video feed showing changing size over time, along with a sequence of left and right feeds exhibiting an offset therebetween as may enable temporal stereo.

FIG. 7 shows a sequence of images approximating frames from a video feed showing rotation over time, along with a sequence of left and right feeds exhibiting an offset therebetween as may enable temporal stereo.

FIG. 8 shows a sequence of images approximating frames from a video feed showing combined translation and rotation over time, along with a sequence of left and right feeds exhibiting an offset therebetween as may enable temporal stereo.

FIG. 9 shows a sequence of images approximating frames from a video feed showing rotation of a feature (though not necessarily an object) over time, along with a sequence of left and right feeds exhibiting an offset therebetween.

FIG. 10 shows a sequence of images approximating frames from a video feed showing translation of a feature (though not necessarily an object) over time, along with a sequence of left and right feeds exhibiting an offset therebetween as may enable temporal stereo.

FIG. 11 shows a sequence of images approximating frames from a video feed showing non-motion as nevertheless may be interpreted as motion over time, along with a sequence of left and right feeds exhibiting an offset therebetween as may enable temporal stereo.

FIG. 12 shows an example method for providing temporal stereo for a video on a mobile electronic device, in flow chart form.

FIG. 13 shows another example method for providing temporal stereo, in flow chart form.

FIG. 14 shows an example method for providing temporal stereo with multiple offset regions, in flow chart form.

FIG. 15 shows an example apparatus for providing temporal stereo to a viewer, in schematic form.

FIG. 16 shows an example apparatus for providing temporal stereo to a viewer, including optical paths, in schematic form.

FIG. 17 shows an example apparatus for providing temporal stereo to a viewer, in perspective view.

FIG. 18 shows another example apparatus for providing temporal stereo to a viewer including optical elements, in perspective view.

FIG. 19 shows an example configuration of executable instructions as may be instantiated on a processor adapted for providing temporal stereo.

FIG. 20 shows a sequence of images approximating frames from a video feed showing horizontal motion, along with a sequence of left and right feeds exhibiting an offset therebetween as may enable temporal stereo via a common display.

FIG. 21 shows an example method for providing temporal stereo for a video on a common-display device, in flow chart form.

FIG. 22 shows another example method for providing temporal stereo in common, in flow chart form.

FIG. 23 shows an example apparatus for providing temporal stereo to a viewer via a common display, in schematic form.

FIG. 24 shows an example configuration of executable instructions as may be instantiated on a processor adapted for providing temporal stereo via a common display.

FIG. 25 is a block diagram illustrating an example of a processing system in which at least some operations described herein may be implemented.

### DETAILED DESCRIPTION OF THE INVENTION

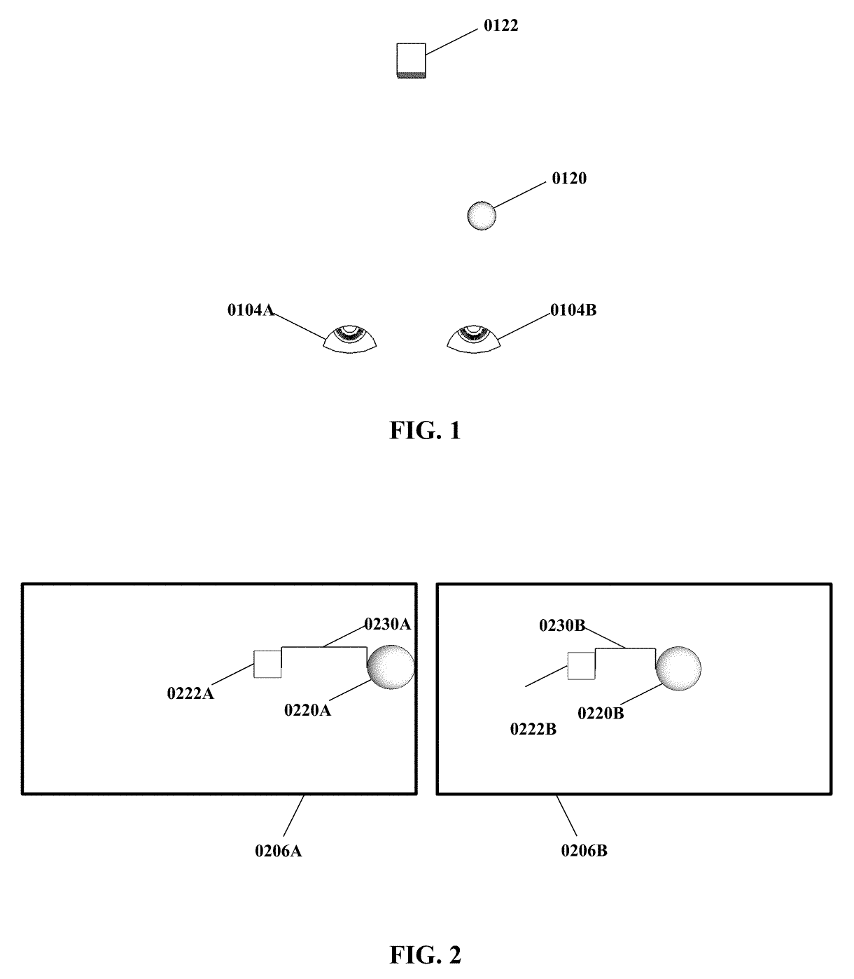

With reference to FIG. 1, therein is shown an arrangement illustrating the operation of spatial depth perception. As may be seen, two objects are disposed in front of the eyes 0104A and 0104B of a viewer, those objects being a sphere 0120 and a cube 0122. Because the left and right eyes 0104A and 0104B are at different positions in space (separated by a distance sometimes referred to as a stereo baseline), the line-of-sight directions to the sphere 0120 and the cube 0122 are different for the left eye 0104A than for the right eye 0104B. For example, from the point of view of the left eye 0104A the cube 0122 may appear offset right of center, while from the point of view of the right eye 0104B the cube 0122 may appear offset left of center. Thus, to the user there may appear to be a horizontal displacement between the position of the sphere in the field of view of the left eye 0104A as compared to the position of the sphere in the field of view of the right eye 0104B. (Although certain examples herein may illustrate and/or refer to eyes and/or a viewer for purposes of explanation, neither the eyes nor the viewer should be understood as necessarily being part of any given embodiment.

Broadly speaking, the greater the apparent displacement as viewed from the left and right eyes 0104A and 0104B, the closer the object may appear to be. Objects or features that exhibit different displacements may be interpreted as being at different distances from the viewer. Objects or features that exhibit no such displacement may be interpreted as being “at infinity”, that is, at a distance too great to resolve given the stereo baseline between the viewer's eyes. In practice the “infinity distance” is not literally infinite, and indeed depending on circumstances may be as little as a few meters or less. Regardless, objects and features that show no displacement may be interpreted as all being at the same effective distance in terms of stereo parallax (though other cues may affect such interpretations).

It is noted that distance interpretations based on such differences in displacement typically may be made at an unconscious level. Typically the viewer's brain fuses the different inputs from the left and right eyes together into a single view without the viewer necessarily even being aware that there are two separate views, assigning relative depths to objects and features without requiring deliberate concentration or effort by the viewer.

Now with reference to FIG. 2, left and right views 0206A and 0206B are shown for a viewer. In the left view 0206A, a sphere 0220A and a cube 0222A are visible, separated by an apparent displacement 0230A. Similarly, in the right view 0206B a sphere 0220B and a cube 0222B are visible, also separated by an apparent displacement 0230B. The arrangements in FIG. 2 may approximate views of left and right eyes in FIG. 1 (though such similarity may be understood as illustrative; exact geometric correspondence may not be maintained). As may be seen, in the left view 0206A the cube 0222A appears right of center, while the sphere 0220A appears farther right. Meanwhile, in the left view 0206B the cube 0222B appears left of center, while the sphere 0220B appears right of center. In addition, the displacement 0230A between the cube 0222A and the sphere 0220A in the left view 0206A is visibly different (larger) than the displacement 0230B between the cube 0222B and the sphere 0220B in the right view 0206B.

Thus, for a viewer fusing left and right views 0206A and 0206B, the contents thereof may be interpreted as indicating that the cube 0222A/0222B and the sphere 0220A/0220B are at different distances—more particularly, that the cube 0222A/0222B is more distant than the sphere 0220A/0220B—and also that both the cube 0222A/0222B and the sphere 0220A/0220B are closer than infinity. A apparent displacements and/or a difference between apparent displacements may present an appearance of depth.

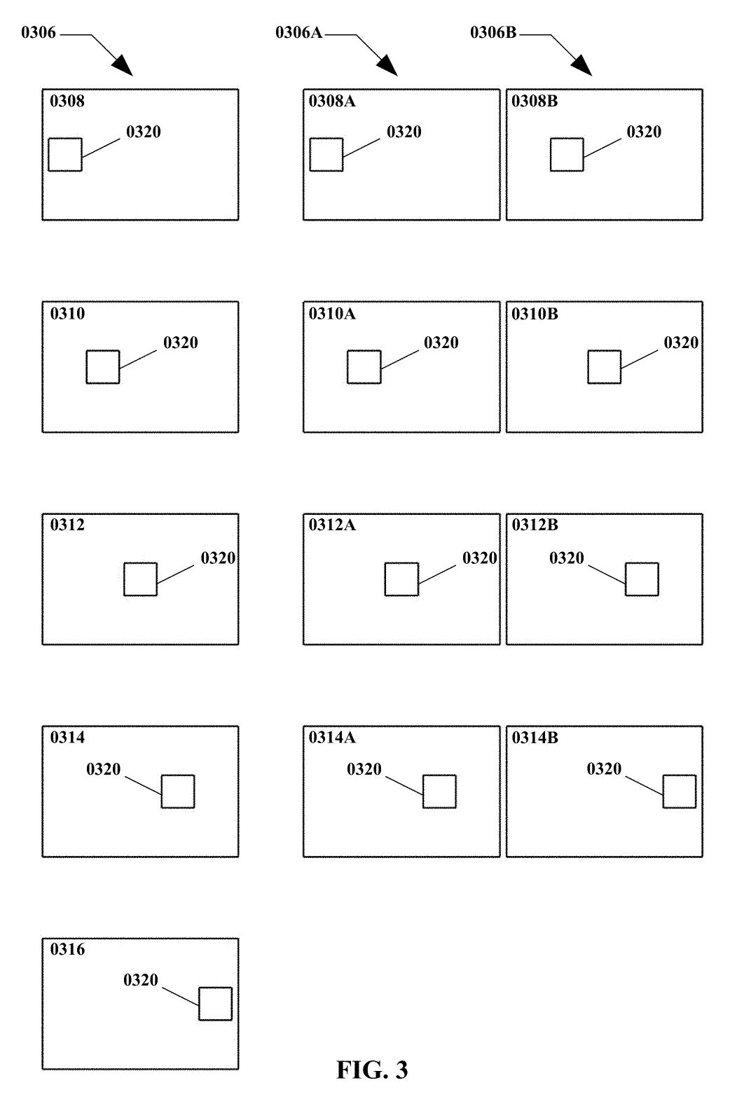

Now with reference to FIG. 3, three sequences of images are shown therein, a base feed 0306, a left feed 0306A, and a right feed 0306B. The feeds as illustrated are presented as individual images, for example as may represent frames from a film, a television or video stream, etc. However, it is emphasized that frame-based feeds are an example only, and that embodiments are not limited to frame based arrangements only. For example, continuously varying video feeds (e.g., as rendered by a computer for virtual/augmented reality) and/or other approaches may also be suitable. However, frames may present a useful paradigm for illustration and explanation, and thus are shown and described with regard to FIG. 3 and certain other examples herein.

As may be seen in FIG. 3, the base feed 0306 includes five frames 0308, 0310, 0312, 0314, and 0316. Each such frame 0308, 0310, 0312, 0314, and 0316 shows a target 0320 therein, in the form of a square as illustrated (though the form of the target 0320 is not limiting). Considered sequentially in the order of frames 0308, 0310, 0312, 0314, and 0316, the base feed 0306 may be interpreted as showing the square 0320 moving horizontally from left to right across the field of view.

The left feed 0306A includes four frames 0308A, 0310A, 0312A, and 0314A, and the right feed also includes four frames 0308B, 0310B, 0312B, and 0314B. Examination of the base feed 0306 and left feed 0306A may reveal that frames 0308A, 0310A, 0312A, and 0314A are identical (or at least very similar) to frames 0308, 0310, 0312, and 0314 respectively. Likewise, examination of the base feed 0306 and right feed 0306B may reveal that frames 0308B, 0310B, 0312B, and 0314B are identical (or at least very similar) to frames 0310, 0312, 0314, and 0316 respectively. Thus, it may be stated that the left and right feeds 0306A and 0306B both approximate portions of the same base feed 0306, but with the right feed 0306B differing from the left feed 0306A by an offset of one frame. In more colloquial terms, the left and right feeds 0306A and 0306B may be presenting “the same video”, but with the right feed 0306B “one frame behind” the left feet 0306A.

If such a left and right feed 0306A and 0306B were presented to a viewer such that the left feed 0306A is displayed to a left eye and the right feed 0306B to a right eye, for example using a stereo display system, the frame offset may result in an apparent displacement of the square 0320 between the left and right feeds 0306A and 0306B as viewed by the viewer's left and right eyes. As noted previously herein, when a viewer sees a displacement of an object or feature as viewed by their left and right eyes, that displacement may be interpreted as an indication of depth. Thus, the square 0320 may appear to be closer to the viewer than whatever background may be present, if any (no background is explicitly illustrated for purposes of simplicity, and in practice a background may not be necessary for the appearance of depth). Such a displacement may be seen to be present for each pair of frames in the left and right feeds 0306A and 0306B: 0308A and 0308B, 0310A and 0310B, 0316A and 0316B, and 0314A and 0314B all exhibit such a displacement. Consequently, a viewer viewing the square 0320 with left and right feeds 0306A and 0306B displayed to left and right eyes may interpret the square 0320 as being closer than (or at least at a different depth than) the background (if any) throughout the sequences of frames in left and right feeds 0306A and 0306B.

Again to use more colloquial (but non-limiting) language, in viewing the same video with both eyes but offset in time between the left and right eyes, a viewer may perceive an appearance of depth. The effect may be similar to spatial stereo, e.g., seeing the same thing with both eyes but from slightly different points in space (the locations of the left and right eyes); however, in the arrangement as shown in FIG. 3 the effect may result from what may be referred to as “temporal stereo”, seeing the same thing with both eyes and from the same perspective in space, but at slightly different points in time for the left and right eyes.

Although the arrangement in FIG. 3 shows the left feed 0306A lagging behind the right feed 0306B (as do certain other examples herein), this is not limiting. Whether the time/frame offset between left and right feeds 0306A and 0306B is due to the left feed 0306A being ahead of the right feed 0306B or the right feed 0306B being ahead of the left feed 0306A may be irrelevant. Typically, either feed 0306A and 0306B may be ahead or behind and still manifest a temporal stereo effect as fused by a viewer.

In principle, an individual may exhibit more pronounced temporal stereo effects, more realistic impressions of depth, etc., if what that viewer sees with their left eye is ahead as compared to their right eye, or vice versa. It is considered for example that at least some persons may have a “dominant” eye and thus visual effects based on providing different views to each eye may be affected by which feed is sent to which eye. Similarly, certain visual content and/or features of content also may at least in principle benefit from the left eye viewing content that is time-offset behind the right, or the other way around. For example, certain directions of motion, directions of light and shadow, color arrangements, etc. may naturally provide a superior impression of depth via temporal stereo if one feed is ahead as opposed to the other.

However, generally speaking, there may be no universal preference as to which feed is offset ahead of or behind the other. More colloquially, the right eye doesn't always have to be ahead of the left, or the other way around, to produce a temporal stereo effect. Moreover, in certain embodiments it may be suitable to change which feed is ahead (left or right) during viewing.

At this point it may be useful to draw attention to several notable features regarding the implementation and/or viewing of temporal stereo.

It is noted that a temporal stereo effect may be implemented using a single video feed as source material. That single original video feed may be presented as left and right feeds by offsetting one such feed to one eye behind the feed to the other eye. That is, modification of the content of the original feed to produce the left and right feeds may not to be required; rather, the same original feed may be merely played to both eyes as-is, but with a time/frame delay in place between what is shown to the left and right eyes. While modifications in feed content and/or other alterations between what is shown to the left and right eye are not prohibited, temporal stereo effects may be achieved through offset alone, with individual frames being unmodified and/or identical and shown in the same order. Thus existing mono feed may be suitable for use in an as-is condition, with little or no change, when providing a temporal stereo effect.

Consequently, temporal stereo depth effects may be produced using content not created or modified specifically for display using temporal stereo. For example, pre-existing or so-called “legacy” video may be provided with an appearance of depth via temporal stereo arrangements as shown and described herein. Similarly, pre-existing or legacy computer games may be resented in temporal stereo, even if no consideration was given to such an approach when the game was programmed. Furthermore, video and games (or other content) may continue to be recorded, programmed or otherwise produced using pre-existing camera equipment, recording techniques, rendering engines, file formats, etc. and still may be presented using temporal stereo arrangements. Stated differently, temporal stereo may be applied at the place and time of display or use, regardless of whether the use of temporal stereo was considered (or even known) at the time and place a video, game, or other content was created. It may be that certain equipment, techniques, etc., as utilized at the time of content creation (e.g., filming) may enhance the appearance of content presented later in temporal stereo; for example, a scene may be filmed or rendered so that objects/features exhibit apparent motion within the field of view as may provide a particular appearance when displayed later in temporal stereo. Thus at least potentially video may be shot in a certain manner so as to improve or optimize temporal stereo effects later, however, such optimization may not be required in order for temporal stereo to be utilized in general.

Likewise, temporal stereo may not require specialized equipment or techniques at the point of presentation. So long as a base feed may be delivered to a viewer's left and right eyes with a time delay therebetween, temporal stereo effects may be provided to the viewer for that video. Indeed, at least in principle, a smart phone screen with a “cardboard headset” may be sufficient for presenting temporal stereo of at least some visual content. (Though more sophisticated and/or specialized approaches are not excluded.) Thus, while complex and/or dedicated head-mounted displays (such as may be designed for VR/AR, etc.) may be utilized in presenting content in temporal stereo, improvised and/or minimal systems also may be suitable.

Moreover, because temporal stereo may be implemented with a single base feed displayed with a (typically) very brief time offset, temporal stereo effects may be provided with live video, and/or otherwise in real time. For example, a live or real-time base feed may be displayed to left and right eyes with a single-frame offset between left and right eyes. (In a very strict sense, it may be possible to argue that a feed to one eye that is for example delayed by 1/24th is not “live”. In practice, such distinction may be moot.) Thus, live content produced as mono base video may be viewed in real time using temporal stereo.

Also, it is noted that the base video feed used for presenting temporal stereo may not require any explicit depth information, per se. For example, temporal stereo may not require stereo depth information, mathematically computed depth information, depth information acquired via sonar or lidar, etc. Thus the imagery for temporal stereo may not in itself include depth information. Even so, an appearance of depth may be provided, regardless of whether any explicit depth information is in fact present. While the presence of such depth information is not necessarily prohibited and may not interfere with a temporal stereo effect, temporal stereo effects may not be diminished by a lack of such explicit depth data. In colloquial terms, temporal stereo techniques may be applied to ordinary mono video, as-is.

As a related matter, since only a single base feed may be required, temporal stereo may present reduced logistical concerns as compared to arrangements requiring two distinct feeds (e.g., left and right spatial stereo camera feeds of a scene), and/or requiring additional information in/about one or more feeds (e.g., time-of-flight depth data regarding distance in a scene). For example, for digital video a single base feed may be stored as a smaller file, may be transmitted more quickly with a given bandwidth, may require less graphical computation or other processing (and thus require a less powerful processor, require less energy, produce less heat, etc.), and so forth as compared arrangements utilizing two distinct base feeds. As a more concrete example, streaming a video for presentation as temporal stereo may require only a single base video feed to be transmitted (e.g., by cable, wifi, etc.), while streaming a spatial stereo video may require that two such video feeds be transmitted at once (thus at least potentially requiring double the bandwidth). As another such example, a video game presented in temporal stereo may require rendering only a single graphical feed of the game environment, while presenting that game in spatial stereo may require rendering two feeds from two distinct spatial perspectives on the game environment (thus at least potentially requiring double the graphical computing power).

Furthermore, the visual work as may be required of a viewer in fusing temporal stereo images/feeds so as to interpret an appearance of depth may be considered as similar to fusing spatial stereo to interpret an appearance of depth. In both cases, a spatial displacement between the position of a feature in two fields of view for a viewer's two eyes may be interpreted as evidence of a depth for that feature. Thus while temporal stereo may include specific, significant, and deliberate modification of video content (e.g., duplicating content and applying an offset in time and/or frames between left and right eyes), interpreting the modified output may place minimal burdens on the viewer. That is, a viewer may simply “watch normally”; no special training, special equipment, etc. may be required. Fusing similar but non-identical images from left and right eyes into a single narrative “view” may be understood as a routine human visual behavior; while the arrangements for preparing and providing those left and right fields may be novel, viewers may find the experience of viewing temporal stereo and fusing images thereof to be natural and/or routine, requiring little or no undue/unfamiliar effort by a viewer and imposing little or no undue/unfamiliar strain to the viewer.

A discussion of certain potentially relevant considerations regarding the manner by which temporal stereo may function/cooperate with human vision, and/or potential variations in temporal stereo effects, also may be illuminating.

Previously with regard to FIG. 3, the offset has been referred to at least principally as a frame offset. As FIG. 3 illustrates arrangements therein in terms of frames, consideration the offset in terms of being “one frame behind” (or potentially two or more frames, etc.) may be useful. However, it also may be suitable to consider an offset in terms of time. For example, for a base feed configured as a 24 frame-per-second video, an offset of one frame may correspond to 1/24th of a second, an offset of two frames as 1/12th of a second, etc. While certain examples herein may refer to frame offsets, offsets are not required to be either configured or considered exclusively in terms of frames, and in particularly addressing offsets as time offsets may be suitable (as may yet other arrangements). The specific manner by which an offset is configured is not limited, nor is the magnitude inherently limited (though as noted certain embodiments may be limited by physical design features, e.g., 24 fps video may use offsets measured in 24ths of a second), nor is the offset limited to being fixed rather than varying (about which more will be said subsequently herein).

With regard to spatial displacements produced by offsets between what is viewed by a viewer's left and right eyes, different magnitudes of displacement may produce different degrees of apparent depth difference between various features. Broadly speaking, zero displacement between left and right eyes for a given feature may be interpreted as indicating that the feature is at infinite depth, while increasingly large displacements may be interpreted as indicating that the feature in question is increasingly close to the viewer. The degree of spatial displacement (and thus in some sense the offset that produces that displacement) as may be viable for presenting an appearance of depth may not be rigidly limited. At some point, a displacement may be so small that no sense of depth is inferred therefrom; the precise point at which a feature is no longer interpreted as being at infinity may vary from one person to another, and may even vary based on the nature of the content being viewed. With regard to maximum displacement, typically the maximum displacement that may be successfully fused may be on the order of 10 degrees of horizontal displacement across the viewer's field of view. Again, this value may vary from one individual to another, based on content, based on other conditions, etc. However, 10 degrees may provide a useful “rule of thumb”.

Displacement fusion limits may be directional, to at least some degree. While a 10 degree horizontal displacement typically may be fusible, also typically the amount of vertical displacement that is fusible may be significantly less. As may be understood, while the horizontal positions of a human's eyes typically are spaced apart by some distance (sometimes referred to as the “interpupillary distance”), also typically the vertical positions of a human's eyes are approximately equal. This may account at least in part for a lower fusibility limit for vertical displacement as compared to horizontal displacement: for two viewing points separated horizontally but not vertically, apparent positions of features being viewed may vary horizontally more (and more often) than vertically. Regardless of mechanism however, typically fusing of vertical displacements may be limited to on the order of 1 degree of arc, as compared with 10 degrees of arc for horizontal displacements.

However, vertical and horizontal displacement limits may not be fully independent. A feature moving diagonally may remain fusible even at (say) 2 degrees of vertical displacement but only if the horizontal displacement remains under 5 degrees. Conversely, a rotating object (e.g., the rim of a rotating circle seen face-on) that presents an effective appearance of more than 1 degree of displacement vertically between left and right eyes may still be fusible if the horizontal displacement thereof remains under 10 degrees. The examples presented here for non-independence should not be understood as either limiting or definitive; in practice what may be fusible may vary greatly among individuals, based on the content being viewed, and due to other conditions.

In sum, typically fusibility may be greater for horizontal displacements than for vertical displacements, but exact limits may vary greatly given the possible ranges of variation and/or factors affecting such ranges. In practice determining an exact “fusibility limit map” either for individuals or a population may not be either necessary or even useful, and (while not prohibited) such mapping should not be understood as being required.

Regardless of the exact maximum fusible displacement for a given individual, embodiment, and/or circumstance, the most pronounced appearance of depth may be achieved when the displacement approaches that maximum. As may be understood, the amount of displacement between two feeds may depend on both the speed of motion (or other change) of a given feature within the feed, and the offset. For a given speed of motion, a larger offset may produce a greater apparent displacement between left and right eyes (other factors being equal). Thus, it may be useful in at least certain embodiments to alter the offset between left and right eyes depending at least in part on the degree of motion exhibited by the base feed at a particular point therein. For example, if motion across the field of view is slow, the offset may be increased to present a greater appearance of depth (or conversely may be decreased if for whatever reason less appearance of depth may be desired), while if motion across the field of view is fast the offset may be decreased. While certain embodiments may provide temporal stereo output with a fixed and/or predetermined offset, other embodiments may allow for varying the offset. Dynamic adjustment of the offset—for example, analyzing the feed to determine how much motion is present and varying the offset over time to increase or decrease the apparent displacement in (or near) real time—also may be suitable. Further, preprogrammed variations in offset also may be suitable, for example a given feed may be analyzed in advance and an actual or recommended offset profile may be encoded as metadata for the video therein, or otherwise associated in some usable form. Depending on the embodiment, variations may be made to maintain a specific level of displacement, to increase or decrease displacement within a range, to maximum displacement, to vary displacement based on the contents of the feed over time, etc.

Certain descriptions herein refer to “motion” across the field of view as contributing to a temporal stereo effect. However, motion per se may not necessarily be required in all instances. Rather, temporal stereo may be exhibited so long as some visible feature propagates through space over time in some manner, regardless of whether any object is literally in motion. For example, a stationary but rotating object may not be moving by certain definitions, but so long as spatial variation is visible it still may be possible to provide a temporal stereo effect. Similarly, some visible feature were to exhibit a color change, brightness change, etc. that propagates through space may exhibit an appearance of depth via temporal stereo. As a more concrete example, consider an arrangement wherein an object is shown stationary with regard to the field of view, but wherein a shadow or reflection of light passes across the object from left to right. Even though by a strict definition no object may be visibly moving, nevertheless a visual cue may be considered to be propagating through space. Indeed, even if there is literally no motion, in certain instances temporal stereo may be achievable. For example, consider a row of lights, wherein one bulb illuminates, then the bulb to the immediate right, and so forth. Nothing in such an example moves; lights merely turn on and off. However, human vision may interpret such a discrete sequence of lights as motion, and so may enable temporal stereo even without any motion at all per se.

Such features (e.g., appearances of depth that may not represent actual depth, appearances of motion that may not be actual motion, etc.) may raise questions as to whether temporal stereo is a “real” effect or an optical illusion. It may be that the apparent depth perceived from a temporal stereo effect is not “real” depth. However, is depth from conventional spatial stereo vision also an illusion? What may be perceived as one view of the world with depth information arguably may be an illusion itself, as a fusion of two two-dimensional images (from left and right eyes). Moreover, human visual depth perception also may be subject to numerous anomalies, and thus in some sense spatial stereo depth information itself arguably may be considered illusory. While consideration of what is “real” and what is “illusion”, “mental construction”, etc. may be of at least philosophical interest, for practical purposes of producing and making use of temporal stereo effects in providing at least an appearance of depth, such questions may be moot.

In addition, human vision may not require that depth cues “be real” in order for viewers to consider a scene as showing depth that “looks real”. Human vision is notoriously subject to optical illusions. In colloquial terms, depth effects from temporal stereo may not have to be entirely correct for viewers to get the impression that a scene “looks right” in terms of depth. For example, it may not be necessary for temporal stereo effects to be present in an entire scene or at all times, or for temporal stereo effects to show precise or accurate depth information, in order for viewers to interpret a scene exhibiting temporal stereo effects as presenting a valid appearance of depth.

It is noted that human vision may not be strictly an optical process, entirely in the eyes. Rather, some portion of “seeing” may be understood as taking place in the brain. For example, in humans high resolution vision and robust color recognition take place only in a small portion of the retina referred to as the macula, typically representing a radial extent of approximately 9 degrees of arc within the visual field. Outside the macular field of view, human color vision and spatial definition may be extremely limited. Despite this, individuals may routinely consider that they are seeing in color and at high resolution throughout their field of view. Typically, so long as an individual may see some portion of the field of view at high resolution and in color, it may be assumed (perhaps unconsciously) that the individual continuously sees the entire field of view at high resolution and in color, whether such assumption is true or not. The human brain may “fill in the blanks” based on limited data.

Such “filling in” may not be limited only to perceptions of color and high resolution. Perceptions regarding depth also may be affected similarly. Such perceptions as regarding depth, whether strictly accurate or not, may prove useful in applying temporal stereo.

For example, if a viewer perceives at least one object or feature in a scene as exhibiting depth cues, there may be a tendency for the viewer to consider the entire scene as exhibiting depth cues. Even if only one object or feature actually presents a perceptible depth via temporal stereo while the rest of the scene is in fact “flat” or two-dimensional, the appearance of depth for that one feature may suggest to a viewer (consciously or not) that the entire scene is composed of objects and features of varying depth. In more colloquial terms, seeing just one indication of 3D may suggest that an entire scene is 3D, even if in fact the scene is essentially 2D with a single object at a different depth from the rest.

Likewise, if a viewer perceives at least one object or feature in a scene as exhibiting depth cues for some period of time, there may be a tendency for the viewer to consider that object/feature (and potentially the entire scene) entire as continuing to exhibit depth cues even if those depth cues are interrupted for a time. For example, if a person runs across the field of view, pauses, then continues running, then typically a temporal stereo effect may be occurring in a literal sense only while the person is moving. (While the person is stationary, the person may exhibit no displacement between left and right eyes.) However, a viewer may still consider the person to exhibit temporal stereo effects while paused, if the person has exhibited temporal stereo effects before the pause and/or exhibits temporal stereo effects after.

In addition, if a viewer perceives at least one object or feature in a scene as exhibiting depth cues, there may be a tendency for the viewer to consider the relative depth for that scene to be “normal”. That is, if there are depth cues present, then regardless of whether the depth cues accord with actual relative depth in a scene, the scene may be interpreted by a viewer as one where depth cues do accord with expected relative depth. As a more concrete example, if a moving vehicle exhibits a temporal stereo effect, if that vehicle passes behind a 2D tree (or other feature) it may be inferred by a viewer (consciously or not) that the tree is closer than the vehicle, even if the tree itself exhibits no temporal stereo or other explicit depth cues. Conversely, if the vehicle passes in front of a 2D tree it may be inferred that the tree is more distant than the vehicle. In both cases the tree itself may exhibit no temporal stereo depth, being essentially “at infinity” in terms of stereo effects. Nevertheless the fact that a vehicle that does show depth cues (e.g., temporal stereo) occludes/is occluded by the tree may not only suggest depth for the tree but various different depths (closer than the vehicle if the tree occludes the vehicle, farther if the tree is occluded by the vehicle).

Such arrangements—wherein the brain may suggest that depth information is present when not actually present, that depth information is more widespread across the field of view than is actually the case, that depth information is more comprehensive than is literally true, that depth information is more accurate than may be the case in fact, etc.—may be understood at least conceptually as similar to the impression that a viewer sees their entire field of view at high resolution and in color, as noted above. Human eyes and/or brains may tend to stitch together information to present an appearance of uniformity of perception, even if such uniformity of perception may not actually be taking place.

As a related matter, it is noted that motion and/or change may draw the attention of viewers. Given that objects and/or features exhibiting motion and/or change may be well-suited for delivering temporal stereo cues of depth (since temporal stereo operates at least in part based on motion/spatial change of features), in some sense temporal stereo may be considered as being “targeted” to present depth cues as may be likely to be noticed by viewers. Thus, since moving objects may both draw the attention of viewers and exhibit depth cues from temporal stereo, then temporal stereo may in effect preferentially apply an appearance of depth in a scene: objects that exhibit temporal stereo via motion through space may also be more likely to be noticed due to such motion through space. In addition, as noted previously depth in a scene may be inferred from depth cues from even a single object or feature therein. If the very objects exhibiting depth cues are objects that are also highly noticeable, the tendency of viewers to consider an entire scene as exhibiting depth. That is, applying depth cues to features that are eye-catching in a scene may facilitate an impression that the entire scene exhibits depth, even if nothing else in that scene presents any depth cues. More colloquially, if temporal stereo manifests in features viewers are naturally inclined to look at, viewers may interpret that the whole scene is in stereo because the features that the viewers are looking at are in (temporal) stereo.

As an additional comment, it is noted that human eyes and/or brains may simply misinterpret information, possibly in a systematic manner, based on normal routine functioning. For example with regard to temporal stereo, a moving object that it is at a distance of two meters may not normally cease to be at two meters and move to infinity when the object stops moving, without some evident cause and/or visual cue. Such things may not be readily encountered in normal life. Consequently, human vision may be adapted to assume that an object that previously exhibited an appearance of depth continues to be at that depth, other factors being equal. While such presumed continuity of depth may be considered a type of optical illusion, the appearance may be convincing even if that appearance may not precisely match explicit data. (If providing an appearance of depth is desired, then whether the appearance is accurate may be secondary to whether the appearance is convincing.)

Stated differently, viewers may tend to interpret depth in a scene as following familiar patterns and behaviors, potentially ignoring cues that may conflict with what is familiar and/or expected. More colloquially, people may see what they expect, so long as visual cues are provided. As a result, even if temporal stereo effects may not be fully accurate, comprehensive, continuous, etc. in so far as reflecting real depths for a real 3D environment, viewers may still form an impression that depths as perceived from temporal stereo are convincing, and/or do not violate suspension of disbelief.

In addition with regard to suspension of disbelief/noticing a time lag as in temporal stereo, it is noted that while it may be possible for viewers to deliberately search for a time lag between left and right eyes, typically viewers may not notice such a time lag without deliberate search. Similarly, it may be possible to deliberately detect individual frames in an animation, look for shadow/reflection errors in computer generated imagery, etc., but it may also be possible to overlook (consciously or unconsciously) certain departures from realism, so long as those departures do not violate suspension of disbelief.

Thus, as noted previously it may not be necessary for temporal stereo effects to provide depth cues that are comprehensive, continuous, or even accurate in order to provide a viewer with an impression of depth, or for viewers to interpret such an impression of depth as being valid. More colloquially, depth effects from temporal stereo may not have to be entirely correct in order for a scene to either appear to have depth or to “look right”.

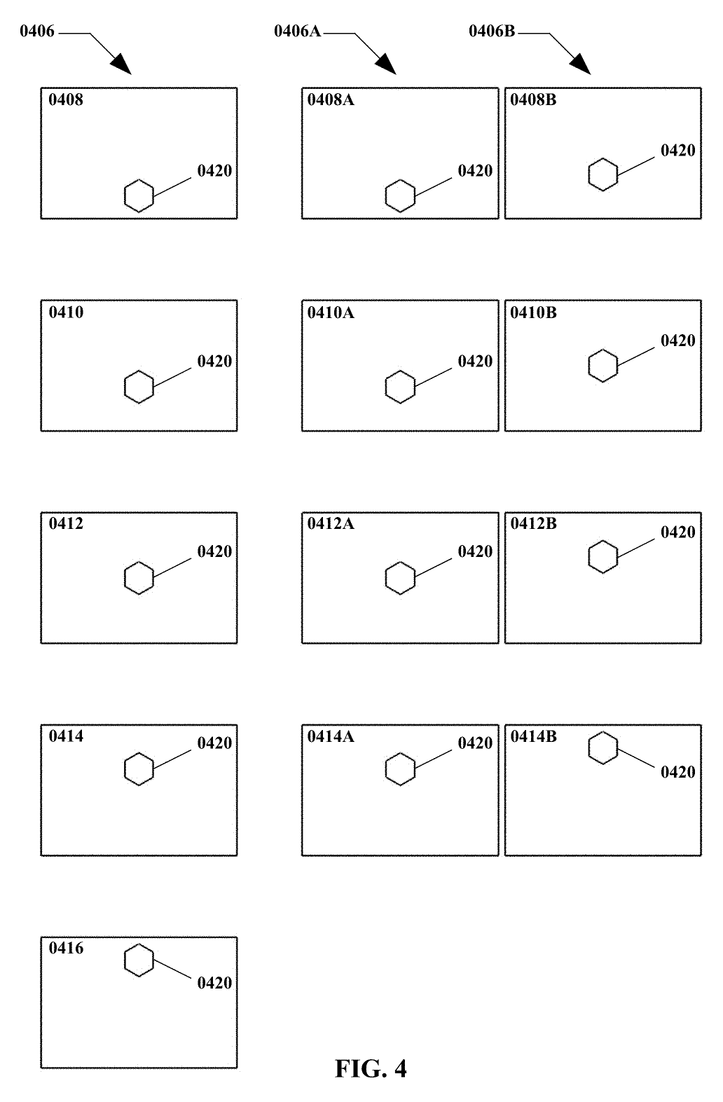

With reference now to FIG. 4 through FIG. 11 collectively, additional example frame sequences are shown. Such sequences may be similar in concept to FIG. 3, e.g., showing a base feed, left feed, and right feed comprising a series of frames. However, various motions and/or other changes in the feeds over time are shown, as may be suitable for temporal stereo display.

Referring specifically to FIG. 4, three sequences of images are shown, a base feed 2006, a left feed 2006A, and a right feed 2006B. As may be seen, the base feed 2006 includes five frames 2008, 2010, 2012, 2014, and 2016. Each such frame 2008, 2010, 2012, 2014, and 2016 shows a target 2020 therein, in the form of a hexagon. Considered sequentially in the order of frames 2008, 2010, 2012, 2014, and 2016, the base feed 2006 may be interpreted as showing the target 2020 moving vertically from bottom to top across the field of view.

The left feed 2006A includes four frames 2008A, 2010A, 2012A, and 2014A, and the right feed also includes four frames 2008B, 2010B, 2012B, and 2014B. As may be seen, frames 2008A, 2010A, 2012A, and 2014A are identical (or at least very similar) to frames 2008, 2010, 2012, and 2014 respectively. Likewise, frames 2008B, 2010B, 2012B, and 2014B are identical (or at least very similar) to frames 2010, 2012, 2014, and 2016 respectively. Thus, the left and right feeds 2006A and 2006B may approximate portions of the base feed 2006, with the right feed 2006B offset one frame behind the left feed 2006A.

If the left and right feeds 2006A and 2006B were presented to a the left and right eye respectively of a viewer, the frame offset may result in an apparent displacement of the target 2020 between the left and right feeds 2006A and 2006B as viewed by the viewer's left and right eyes. Thus, the target 2020 may appear to be closer to the viewer than whatever background may be present, if any. Such a displacement may be seen to be present for each pair of frames in the left and right feeds 2006A and 2006B: 2008A and 2008B, 2010A and 2010B, 2016A and 2016B, and 2014A and 2014B all exhibit a displacement. Consequently, a viewer viewing the target 2020 with left and right feeds 2006A and 2006B displayed to left and right eyes may interpret the target 2020 as being closer than (or at least at a different depth than) the background (if any) throughout the sequences of frames in left and right feeds 2006A and 2006B.

As also noted previously, viewers may tend to fuse vertical displacements less effectively than horizontal displacements. Thus, in practice it may be useful to limit vertical displacements to smaller magnitudes than may be the case for horizontal displacements, in at least certain instances. For example, by using a smaller offset (e.g., a fewer number of frames, a briefer time delay, etc.) a motion at a given speed may present a smaller apparent displacement when displayed as left and right feeds 2006A and 2006B. However, vertical displacement is not prohibited, and objects and/or features exhibiting vertical displacement may be suitable for presentation using temporal stereo.

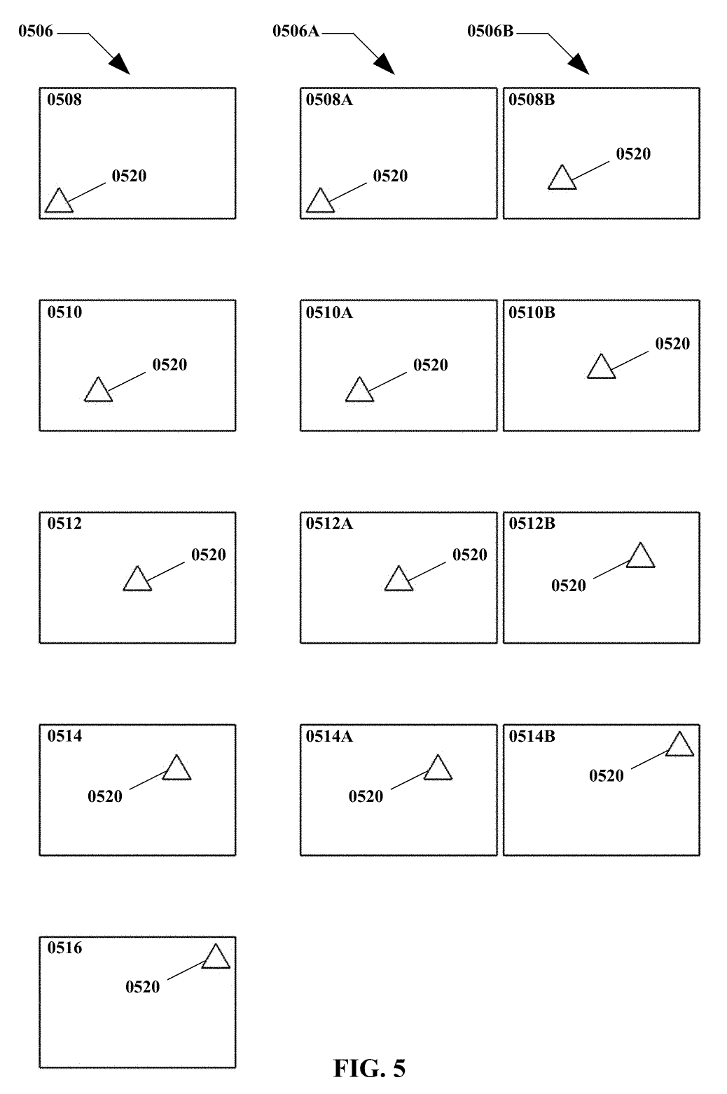

Referring now to FIG. 5, a base feed 0506, a left feed 0506A, and a right feed 0506B are shown. The base feed 0506 includes five frames 0508, 0510, 0512, 0514, and 0516. Each frame 0508, 0510, 0512, 0514, and 0516 shows a target 0520 therein, in the form of a triangle. The base feed 0506 may be interpreted as showing the target 0520 moving diagonally from bottom left to top right across the field of view.

The left feed 0506A includes four frames 0508A, 0510A, 0512A, and 0514A, and the right feed also includes four frames 0508B, 0510B, 0512B, and 0514B. Frames 0508A, 0510A, 0512A, and 0514A are identical (or at least very similar) to frames 0508, 0510, 0512, and 0514 respectively, and frames 0508B, 0510B, 0512B, and 0514B are identical (or at least very similar) to frames 0510, 0512, 0514, and 0516 respectively. Thus, the left and right feeds 0506A and 0506B may approximate portions of the base feed 0506, with the right feed 0506B offset one frame behind the left feed 0506A.

If the left and right feeds 0506A and 0506B were presented to a the left and right eye of a viewer, the frame offset may present an apparent displacement of the target 0520 as viewed by the viewer's left and right eyes. Thus, a viewer viewing the target 0520 with left and right feeds 0506A and 0506B may interpret the target 0520 as being closer than (or at least at a different depth than) the background (if any) throughout the sequences of frames in left and right feeds 0506A and 0506B.

As noted previously, horizontal and vertical displacements may be fused differently, and/or subject to different limits (e.g., maximum angular distance) for fusing by a viewer. However, combining motions, even with different fusing limits, nevertheless may be suitable. Indeed, in at least certain circumstances a combined motion may be fusible to a different degree than components thereof, for example a diagonal motion as shown in FIG. 5 may be more fusible than the less fusible component thereof (e.g., the vertical motion) viewed separately. Regardless, motions are not limited only to a single direction, dimension, type, etc., and fusing limits may vary depending upon numerous factors including but not limited to the component motions.

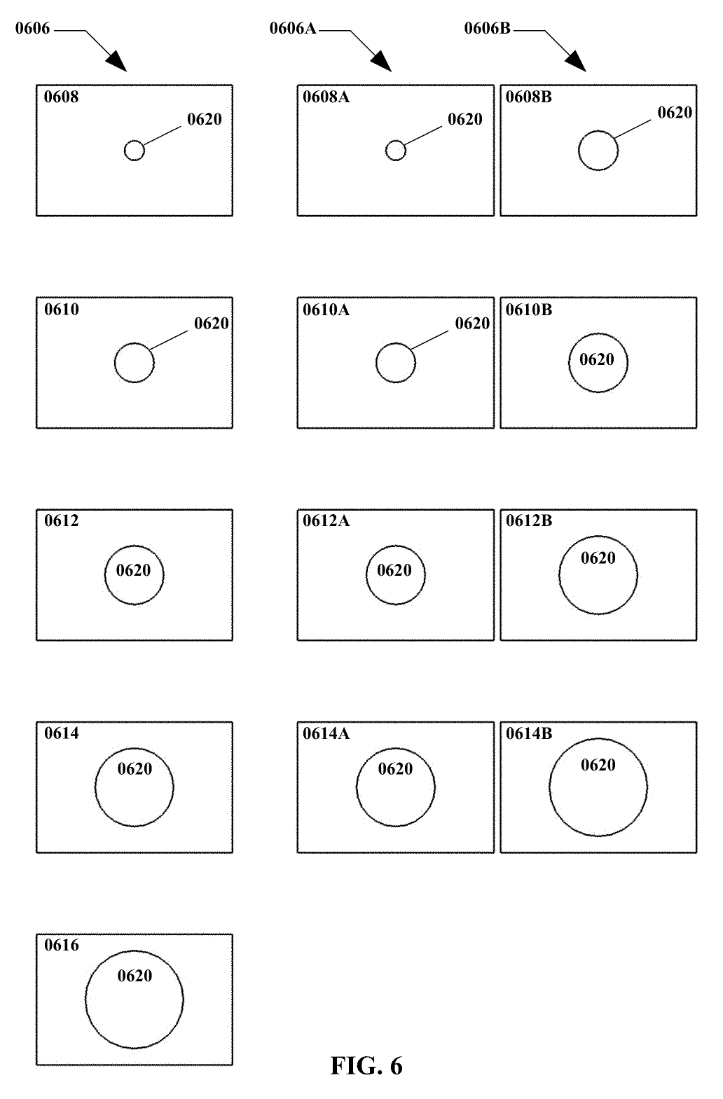

Moving on to FIG. 6, a base feed 0606, a left feed 0606A, and a right feed 0606B are shown. The base feed 0606 includes five frames 0608, 0610, 0612, 0614, and 0616. Each frame 0608, 0610, 0612, 0614, and 0616 shows a target 0620 therein, in the form of a circle of varying size. The base feed 0606 may be interpreted as showing the target 0620 expanding over time.

The left feed 0606A includes four frames 0608A, 0610A, 0612A, and 0614A, and the right feed also includes four frames 0608B, 0610B, 0612B, and 0614B. Frames 0608A, 0610A, 0612A, and 0614A are identical (or at least very similar) to frames 0608, 0610, 0612, and 0614 respectively, and frames 0608B, 0610B, 0612B, and 0614B are identical (or at least very similar) to frames 0610, 0612, 0614, and 0616 respectively. Thus, the left and right feeds 0606A and 0606B may approximate portions of the base feed 0606, with the right feed 0606B offset one frame behind the left feed 0606A.

The center of the circle 0620 may appear (and may be) stationary as illustrated in FIG. 6. Thus by certain definitions it may be that the circle 0620 does not move, in that the center thereof does not translate in space. However, temporal stereo effects are not necessarily limited to translation of objects per se; motion of and/or change by features may be sufficient. For example, as the circle 0620 expands the perimeter thereof moves, that is, the left-most edge of the circle moves farther left, the right-most edge moves farther right, etc. Thus, regardless of whether growth may be defined as motion in a strict geometric sense, if the left and right feeds 0606A and 0606B showing the growing circle 0620 were presented to a the left and right eye of a viewer, the frame offset may present an apparent displacement. Thus, a viewer viewing the target 0620 with left and right feeds 0606A and 0606B may interpret the target 0620 and/or portions of the target 0620 as being closer than (or at least at a different depth than) the background (if any) throughout the sequences of frames in left and right feeds 0606A and 0606B.

While the arrangement in FIG. 6 presents an increase in size, as may be understood a decrease in size, changes in relative proportions and/or shape without a change in area, and/or other variations also may be suitable for presenting temporal stereo effects.

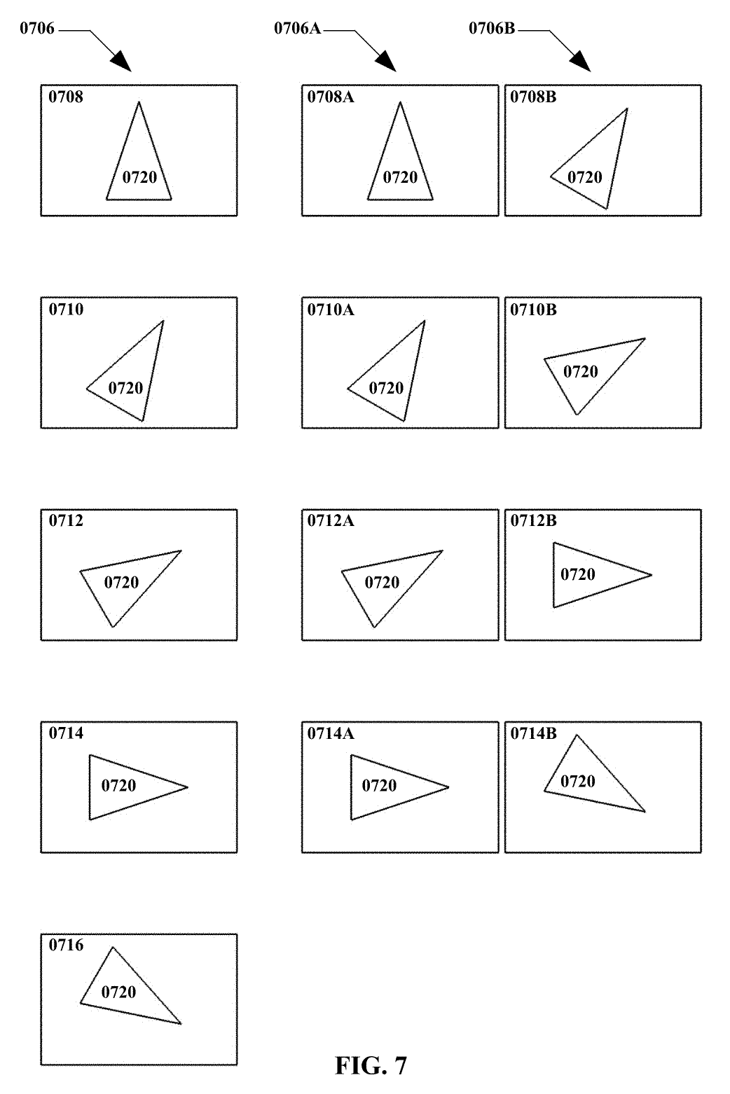

Turning to FIG. 7, a base feed 0706, a left feed 0706A, and a right feed 0706B are shown. The base feed 0706 includes five frames 0708, 0710, 0712, 0714, and 0716. Each frame 0708, 0710, 0712, 0714, and 0716 shows a target 0720 therein, in the form of an isosceles triangle in different orientations. The base feed 0706 may be interpreted as showing the target 0720 rotating in place.

The left feed 0706A includes four frames 0708A, 0710A, 0712A, and 0714A, and the right feed also includes four frames 0708B, 0710B, 0712B, and 0714B. Frames 0708A, 0710A, 0712A, and 0714A are identical (or at least very similar) to frames 0708, 0710, 0712, and 0714 respectively, and frames 0708B, 0710B, 0712B, and 0714B are identical (or at least very similar) to frames 0710, 0712, 0714, and 0716 respectively. Thus, the left and right feeds 0706A and 0706B may approximate portions of the base feed 0706, with the right feed 0706B offset one frame behind the left feed 0706A.

As with the circle in FIG. 6, the center of the isosceles triangle 0720 may appear (and may be) stationary as illustrated in FIG. 7. However, as also noted, motion of and/or change by features may be sufficient for providing temporal stereo effects. For example, as the isosceles triangle 0720 rotates various portions of the perimeter thereof move up, down, left, right, etc. Thus if the left and right feeds 0706A and 0706B showing the rotating isosceles triangle 0720 were presented to a the left and right eye of a viewer, the frame offset may present an apparent displacement. Thus, a viewer viewing the target 0720 with left and right feeds 0706A and 0706B may interpret the target 0720 and/or portions of the target 0720 as being closer than (or at least at a different depth than) the background (if any) throughout the sequences of frames in left and right feeds 0706A and 0706B.

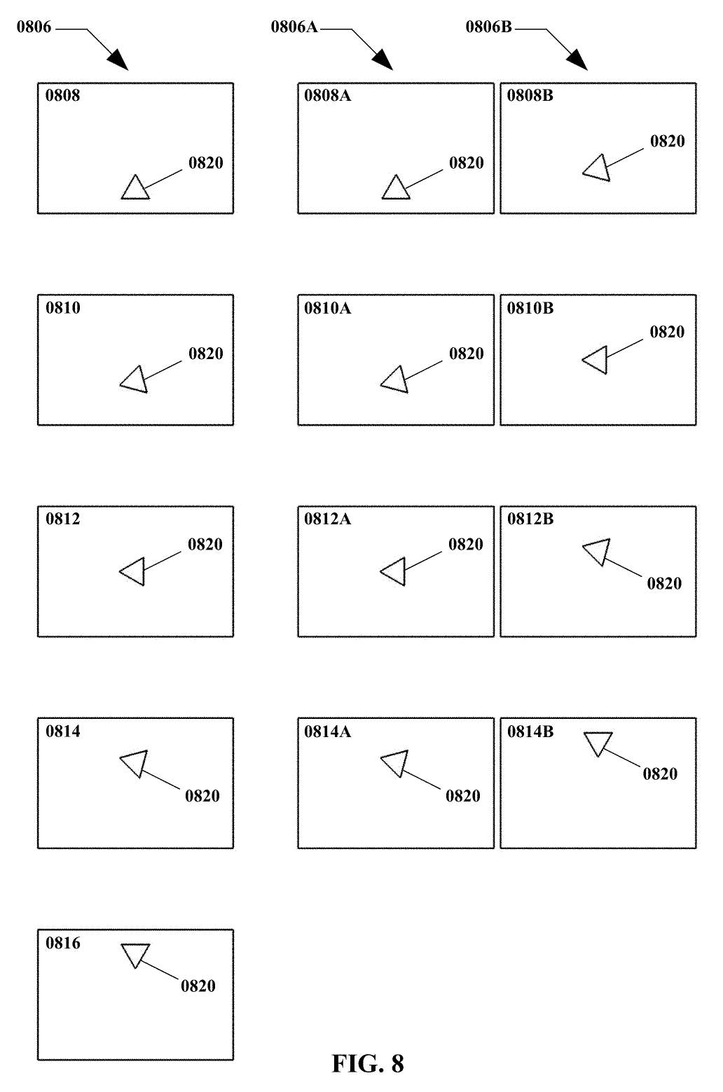

Now with reference to FIG. 8, a base feed 0806, a left feed 0806A, and a right feed 0806B are shown. The base feed 0806 includes five frames 0808, 0810, 0812, 0814, and 0816. Each frame 0808, 0810, 0812, 0814, and 0816 shows a target 0820 therein, in the form of a triangle. The base feed 0806 may be interpreted as showing the target 0820 moving from bottom to top across the field of view while also rotating over time.

The left feed 0806A includes four frames 0808A, 0810A, 0812A, and 0814A, and the right feed also includes four frames 0808B, 0810B, 0812B, and 0814B. Frames 0808A, 0810A, 0812A, and 0814A are identical (or at least very similar) to frames 0808, 0810, 0812, and 0814 respectively, and frames 0808B, 0810B, 0812B, and 0814B are identical (or at least very similar) to frames 0810, 0812, 0814, and 0816 respectively. Thus, the left and right feeds 0806A and 0806B may approximate portions of the base feed 0806, with the right feed 0806B offset one frame behind the left feed 0806A.

The triangle 0820 illustrated in FIG. 8 exhibits both translation, e.g., vertical motion from top to bottom, and rotation. As noted previously, combinations of motions (and/or other changes) may be suitable for presentation of temporal stereo, and embodiments are not limited with regard to specific motions and/or combinations thereof. In addition, as also noted with regard to FIG. 5, in at least certain instances combining motions may facilitate visual fusion for a viewer with displacement limits different than, and potentially greater than, one (or even both) of the motions alone. Thus, it may be that rotating a target 0820 that is also moving vertically as shown in FIG. 8—wherein such rotation includes at least some degree of horizontal motion of the perimeter of the triangle 0820 as the triangle 0820 rotates—may contribute to a higher displacement limit for fusion (and thus potentially a more pronounced appearance of depth) than for vertical motion alone. Such considerations may be of interest when determining time/frame offsets for a given base feed, and/or when planning behavior of content when creating media so as to improve or optimize temporal stereo effects.

Regardless, if the left and right feeds 0806A and 0806B showing the target 0820 were presented to a the left and right eye of a viewer, the frame offset may present an apparent displacement. Thus, a viewer viewing the target 0820 with left and right feeds 0806A and 0806B may interpret the target 0820 and/or portions of the target 0820 as being closer than (or at least at a different depth than) the background (if any) throughout the sequences of frames in left and right feeds 0806A and 0806B.

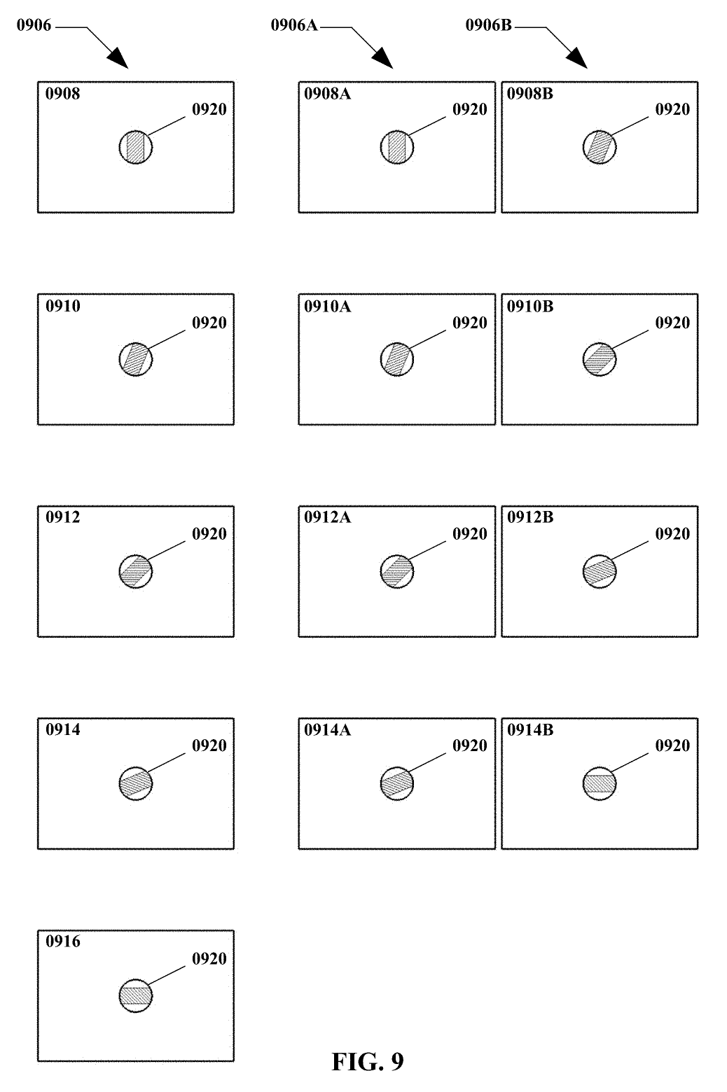

Referring to FIG. 9, a base feed 0906, a left feed 0906A, and a right feed 0906B are shown. The base feed 0906 includes five frames 0908, 0910, 0912, 0914, and 0916. Each frame 0908, 0910, 0912, 0914, and 0916 shows a target 0920 therein, in the form of a circle. As may be seen, the target 0920 does not translate from frame to frame, nor does the perimeter of the target 0920 move or change in shape or size. However, the circle 0920 includes a central stripe represented by a hatched area, as may represent a different color, different texture, etc. Thus the base feed 0906 may be interpreted as showing the target 0920 rotating in place over time, or at least may be interpreted as showing that the stripe (a feature on/of the target 0920) rotating in place over time.

The left feed 0906A includes four frames 0908A, 0910A, 0912A, and 0914A, and the right feed also includes four frames 0908B, 0910B, 0912B, and 0914B. Frames 0908A, 0910A, 0912A, and 0914A are identical (or at least very similar) to frames 0908, 0910, 0912, and 0914 respectively, and frames 0908B, 0910B, 0912B, and 0914B are identical (or at least very similar) to frames 0910, 0912, 0914, and 0916 respectively. Thus, the left and right feeds 0906A and 0906B may approximate portions of the base feed 0906, with the right feed 0906B offset one frame behind the left feed 0906A.

The center of the circle 0920 and the perimeter thereof may both appear (and may be) stationary as illustrated in FIG. 9. However, changes to features thereof—e.g., rotation of the stripe as shown—may be sufficient to facilitate temporal stereo. Thus, a viewer viewing the target 0920 with left and right feeds 0906A and 0906B may interpret the target 0920 and/or portions of the target 0920 as being closer than (or at least at a different depth than) the background (if any) throughout the sequences of frames in left and right feeds 0906A and 0906B.

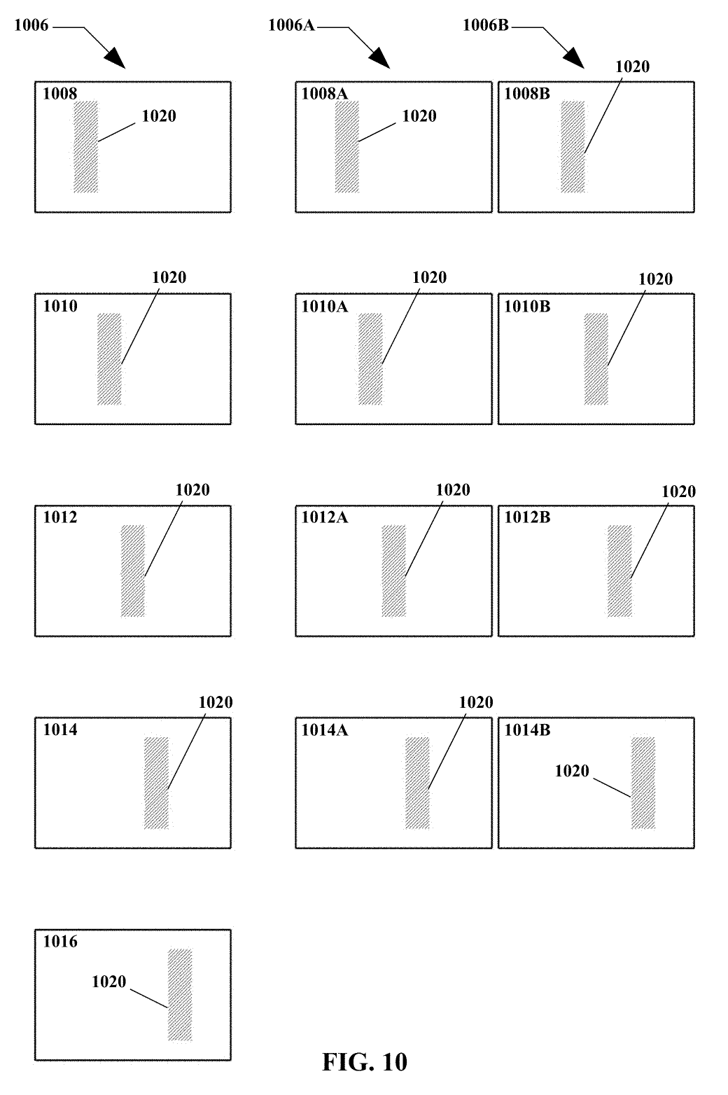

Moving on to FIG. 10, a base feed 1006, a left feed 1006A, and a right feed 1006B are shown. The base feed 1006 includes five frames 1008, 1010, 1012, 1014, and 1016. Each frame 1008, 1010, 1012, 1014, and 1016 shows a target 1020 therein, in the form of a rectangular region. The base feed 1006 may be interpreted as showing the region 1020 moving horizontally.

The left feed 1006A includes four frames 1008A, 1010A, 1012A, and 1014A, and the right feed also includes four frames 1008B, 1010B, 1012B, and 1014B. Frames 1008A, 1010A, 1012A, and 1014A are identical (or at least very similar) to frames 1008, 1010, 1012, and 1014 respectively, and frames 1008B, 1010B, 1012B, and 1014B are identical (or at least very similar) to frames 1010, 1012, 1014, and 1016 respectively. Thus, the left and right feeds 1006A and 1006B may approximate portions of the base feed 1006, with the right feed 1006B offset one frame behind the left feed 1006A.

The region 1020 as illustrated exhibits no perimeter. In practice, the region 1020 may not have a well-defined physical or other boundary, and indeed may not be an object or even a permanent or physical feature such as a painted-on stripe of color. For example, the region may be an area of shadow, light, reflection, heat shimmer, etc. within the base feed 1006. Physicality may not be required for temporal stereo; even a moving shadow or similarly insubstantial effect may be sufficient to present depth cues via temporal stereo. So long as some visible change is provided as may be visually interpreted as motion, features suitable for presentation via temporal stereo are not limited, and in particular are not limited only to physical objects and/or features.

As noted previously, depth cues from temporal stereo may not be entirely accurate. A shadow on a surface typically may exhibit the same depth as that surface, in a geometric sense. However, the shadow still may present the appearance of being at a different depth from the surface onto which the shadow is projected, via temporal stereo, if that shadow is moving or changing over time. As also noted previously, depth cues may not be required to be accurate; the mere cue that some degree of depth exists within a scene may in at least some instances be interpreted by a viewer as an indication that the scene shows full and/or proper depth. This may remain true even if the depth change in question may be physically impossible, e.g., a shadow being at a different depth than the surface on which that shadow is projected.

Thus, regardless of whether the region 1020 may be considered as an object or physical feature, if the left and right feeds 1006A and 1006B showing the region 1020 were presented to a the left and right eye of a viewer, the frame offset may present an apparent displacement. Thus, a viewer viewing the target 1020 with left and right feeds 1006A and 1006B may interpret the target 1020 and/or portions of the target 1020 as being closer than (or at least at a different depth than) the background (if any) throughout the sequences of frames in left and right feeds 1006A and 1006B.

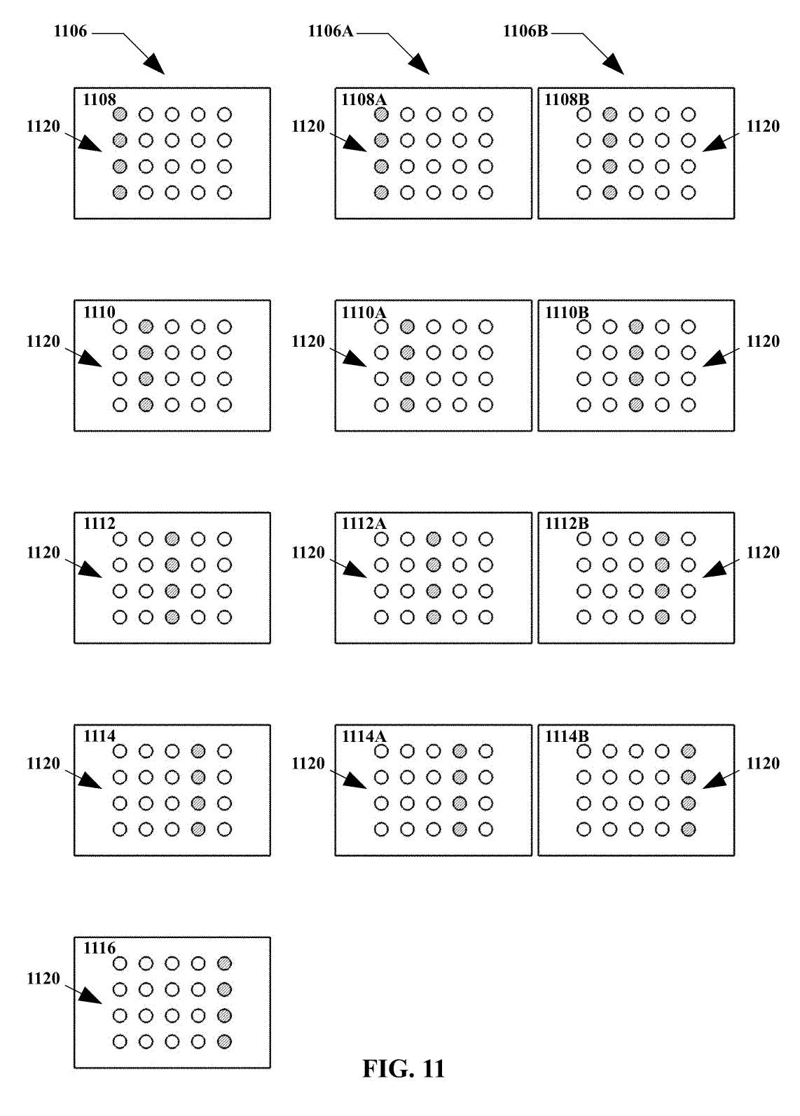

Now with reference to FIG. 11, as noted with regard to FIG. 10 a literal object may not be required for providing temporal stereo. Likewise with respect to FIG. 11, a literal motion also may not be required. As may be seen in FIG. 11, a base feed 1106, a left feed 1106A, and a right feed 1106B are shown. The base feed 1106 includes five frames 1108, 1110, 1112, 1114, and 1116. Each frame 1108, 1110, 1112, 1114, and 1116 shows a plurality of targets 1120 therein, in the form of a four by five array of circles. In each frame of the base feed 1106, one column of four targets 1120 is shown hatched, for example as to represent being illuminated or darkened, exhibiting a different color, etc. The base feed 1106 may be interpreted as showing the array of targets 1120 collectively changing over time.

The left feed 1106A includes four frames 1108A, 1110A, 1112A, and 1114A, and the right feed also includes four frames 1108B, 1110B, 1112B, and 1114B. Frames 1108A, 1110A, 1112A, and 1114A are identical (or at least very similar) to frames 1108, 1110, 1112, and 1114 respectively, and frames 1108B, 1110B, 1112B, and 1114B are identical (or at least very similar) to frames 1110, 1112, 1114, and 1116 respectively. Thus, the left and right feeds 1106A and 1106B may approximate portions of the base feed 1106, with the right feed 1106B offset one frame behind the left feed 1106A.

It is noted that none of the targets 1120 in FIG. 11 is illustrated as either translating or rotating. In a literal sense, it may be said that no motion is occurring. Nevertheless, in viewing frames 1108, 1110, 1112, 1114, and 1116 a human viewer may interpret such a sequence as showing motion: the shaded column may be viewed as “moving to the right”, even though no actual motion is taking place. Such illusory motion may be similarly viewed for example in a row of lights, wherein one such light is illuminated, then darkened while an adjacent light is illuminated, and so forth down the row. No actual motion may be present, but human vision may interpret motion as being present. Even such illusory motion, where no actual motion exists, may in at least some embodiments be sufficient to present an appearance of depth via temporal stereo. Whether motion really exists may be immaterial, so long as a viewer may perceive motion to be taking place.

Thus, regardless of whether any literal motion is present in the arrangement shown in FIG. 11, if the left and right feeds 1106A and 1106B showing the array of targets 1120 were presented to a the left and right eye of a viewer, the frame offset may present an apparent displacement. Thus, a viewer viewing the target 1120 with left and right feeds 1106A and 1106B may interpret the array of targets 1120 and/or portions of the array of targets 1120 as being closer than (or at least at a different depth than) the background (if any) throughout the sequences of frames in left and right feeds 1106A and 1106B.

With regard to FIG. 3 through FIG. 11 collectively, “motion”, “displacement”, etc., should be understood broadly in terms of facilitating temporal stereo. Motion and/or change of many different forms, in many different directions, with or without well-defined objects, and even with or without any actual motion, may be suitable for presentation via temporal stereo so as to present an appearance of depth in a scene.

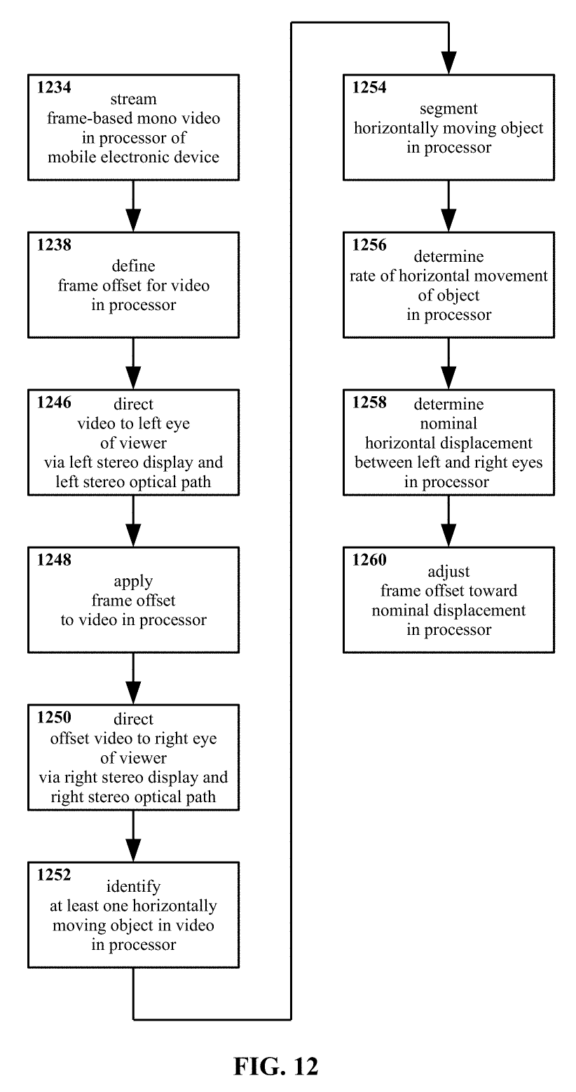

Now with reference to FIG. 12, therein an example method for providing an appearance of depth via temporal stereo is illustrated, in flow chart form. The example presented therein is described in relatively specific and concrete form, for clarity of explanation. However, it is emphasized that the arrangements in FIG. 12 are an example only, and that not all steps and/or features referenced therein necessarily must be present in all embodiments. Similarly, while other particular examples may be presented herein in at least certain instances (e.g., use of a mobile electronic device, streaming video, etc.), these too are examples only and should not be understood as limiting.

In the example arrangement of FIG. 12, a frame based mono (e.g., two dimensional) video is streamed 1234 in the processor of a mobile electronic device, such as a head mounted display. However, embodiments are not limited only to head mounted displays, or indeed only to portable electronic devices. Regardless of the particulars of hardware (if any), a frame offset is defined 1238 for the video, for example in the processor of a mobile electronic device. For instance, a frame offset of two frames ( 1/24th of a second at 48 fps) may be defined 1238. Typically though not necessarily, such definition 1238 may be carried out through executable instructions instantiated onto the processor.

The video stream is directed 1246 to the left eye of a viewer, by way of a left stereo display and a left stereo optical path. For example, a stereo head mounted display may include a left screen, or a left portion of a single screen, adapted to output graphical content to a viewer's left eye therethrough. In such instance the optical path may be a simple straight line through empty space (e.g., from the left display to the left eye). However an optical path also may include lenses, prisms, fiber optics, light pipes, mirrors, some combination thereof, etc. The left optical path is not limited, nor is the manner by which the video feed is directed (e.g., type of display, configuration, etc.).

Continuing in FIG. 12, the frame offset is applied 1248 to the video by the processor. To continue the example above, if the offset was defined 1238 as two frames, then the video is offset 1248 (either forward or backward) by two frames. The offset video—that is, the video with the offset having been applied 1248 thereto—is then directed 1250 to the right eye of a viewer, by way of a right stereo display and a right stereo optical path. As with the left optical path and left display, the right optical path and right display are not limited.

Typically the left and right displays and/or left and right optical paths may be configured so as to facilitate stereo fusing by the viewer. As described previously herein, temporal stereo effects may function at least in part through the viewer fusing left and right images to infer an impression of depth therefrom, thus it may be preferable for at least some embodiments if displays and/or optical paths are adapted for comfortable and/or convenient fusing by viewers. However, the particulars of stereo displays and optics may vary considerably, and are not otherwise limited.

At least one horizontally moving object or other feature is identified 1252 by the processor within the video. For example, given a video showing an automobile moving across the screen, the automobile may be so identified. Identification 1252 of motion within video may be accomplished in a variety of ways, and is not limited. In addition, while the example of FIG. 12 specifies horizontal motion, in other embodiments it may be suitable to identify different directions of motion, different forms of motion (e.g., rotation), etc. Also, if more than one moving feature is present in a given portion of a video, it is not required that all features exhibiting movement, or any particular number, be identified, so long as at least one such moving feature is identified 1252.

The object or feature identified 1252 is then segmented 1254 from the video in the processor. That is, a distinction is determined as to what constitutes the object or feature and what does not (e.g., instead being background). To continue the example of a moving automobile, the boundaries or outline of the automobile may be determined in one or more frames. The manner of segmentation is not limited. With the object segmented 1254, the rate of horizontal motion of the object is determined 1256 in the processor. Typically though not necessarily, the rate of horizontal motion may be determined 1256 in terms of viewing angle, that is, the apparent angle of motion (e.g., per second or per frame) across the field of view.

A determination is then made 1258 as to the nominal or preferred amount of horizontal displacement between the apparent position of objects as viewed by the left eye (for the video without the offset) as compared with the right eye (for the video with the offset). For example, this may be a simple maximum limit, e.g., horizontal displacement is not to exceed 10 degrees. However, what may be considered as a preferred amount of horizontal displacement (and likewise, vertical displacement, etc.) may be determined 1258 by arrangements that are considerably more complex and that may consider numerous factors, such as the content of the video, the image quality, the preferences of a particular viewer, etc. In addition, what constitutes a preferred or nominal displacement may vary over time, again due to a range of factors. The determination of nominal displacement is not limited.

Still with reference to FIG. 12, the frame offset may be adjusted 1260 so as to shift the actual displacement toward the nominal displacement. For example, the frame offset may be increased or decreased to maintain an approximately constant displacement throughout the video or some portion thereof, may be adjusted as the nominal displacement value changes (assuming the nominal value does change), etc. Adjustment 1260 to frame offset may not be required for all embodiments (and thus steps associated therewith such as 1252, 1254, 1256, and 1258) also may not be present. Even when a given embodiment is adapted for adjusting frame offset, such adjustment is not necessarily required at all times.

While the arrangement in FIG. 12 does not explicitly continue after step 1260, in practice a method may continue, may loop back, etc. For example, after the frame offset is adjusted 1260, certain embodiments may return to step 1248 to apply the new offset and then continue looping through steps 1248 through 1260 while the video is streamed. Other arrangements also may be suitable.

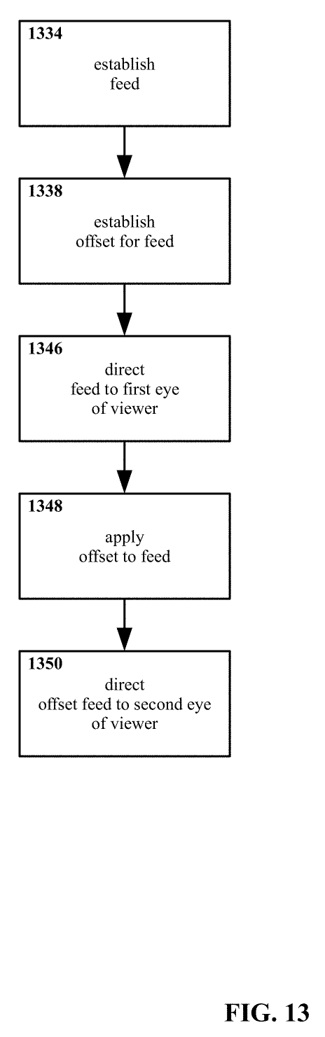

As noted, the arrangement in FIG. 12 is an example presented with specific features for clarity, but not all such features may be present in all embodiments. Turning now to FIG. 13, a somewhat more general (but still not necessarily limiting) example method is presented.

In the arrangement of FIG. 13, a feed is established 1334. For example, the feed (at least similar to what may be referred to elsewhere herein as a “base feed”) may include streaming video, but may also include rendered or stored game content, stored video files, and/or other media. The contents of the feed are not limited. Likewise, the manner by which the feed may be established 1334 is not limited: a feed may be produced by rendering a 2D or 3D model, by playing stored data, by accessing remote data, etc.

An offset for the feed is also established 1338. As noted previously, the offset may be in the form of a time delay, may be in the form of a number of frames of delay (for frame based content), or may take some other form. The form of the offset is not limiting. The manner by which the offset is established also is not limiting, and may vary considerably. For example, a particular video may include a profile of required or recommended offsets throughout the run time thereof, or an offset may be fixed for a given device, user, or feed, or an offset may be determined on-the-fly based on the contents of the feed, etc. Other arrangements also may be suitable. Further, the magnitude of the offset is not limited. That is, no absolute maximum or minimum amount of offset may be required (though in practice at some point an offset may be too small to yield noticeable displacements, or may be too large to facilitate visual fusion). Also, although in certain instances herein the offset may be referred to as a lag, or a delay, etc., it is not required that an offset necessarily represent a delay; a left or right feed may be advanced over the other, rather than retarded. (In practice there may be little or no difference between advancing one feed by, for example, 2 frames, and retarding the other feed by 2 frames. Regardless, either approach may be suitable.) Further, either feed (left or right, or as referred to with regard to FIG. 13 first or second) may be ahead of or behind the other, without limit.

Continuing in FIG. 13, the feed (without offset) is directed 1346 to a first eye of a viewer. For example, the feed may be directed via a display, via an optical pathway, etc., though the manner by which the feed is directed toward a viewer's eye is not limited. The offset is applied 1348 to the feed, and the offset feed is also directed 1350 to a second eye of the viewer.

It is noted that the arrangement of FIG. 13 does not explicitly include ongoing adjustment of the offset, as was shown for example in FIG. 12. While such adjustment is not prohibited, neither is such adjustment required for all embodiments.

In addition, as has been described, typically once a viewer receives both the original and offset feeds, the viewer may fuse those feeds visually and so be provided with an impression of depth for the scene being viewed. However, the viewer is not necessarily considered an explicit part of a given embodiment, nor is the action of visual fusion (e.g., as taking place within the viewer's eyes and/or brain) necessarily considered part of an embodiment, either.

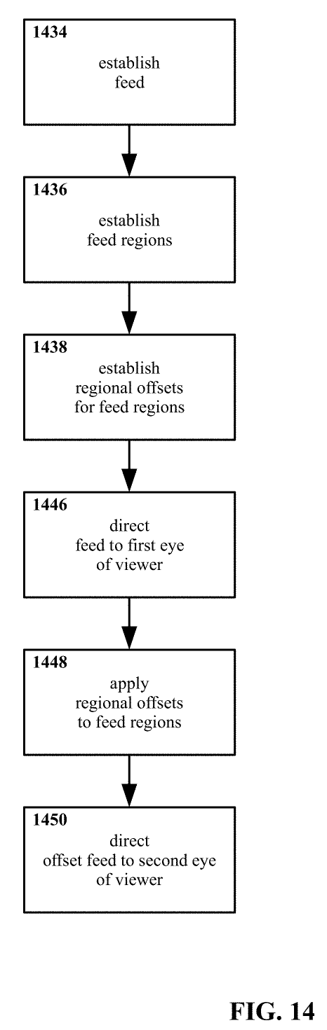

Now with reference to FIG. 14, in certain examples offset may be referred to with regard to entire frames or feeds being offset, e.g., a feed being uniformly retarded by two frames across the entire field of view. However, for certain embodiments it may be suitable to offset different regions or features of a video to different degrees or in different directions (e.g., advanced or retarded), and/or to offset some regions or features without offsetting others. For example, it may be useful to select certain objects of interest within a given feed and offset those objects only, so as to present an appearance of depth for those objects only, or preferentially compared to the rest of the video. Alternately, it may be useful to present an appearance of depth only for the lower half of a field of view (e.g., below some horizon line in the content thereof), etc. Typically such an arrangement may require or at least benefit from processing of the feeds, for example segmenting objects therefrom so that only those particular objects are offset. However, the particulars of how such “targeted” offsetting may vary considerably, and are not limited.

In FIG. 14, a feed is established 1434. Feed regions are established 1436 for/within that feed. For example, a feed region may be defined geometrically, e.g., the lower right quadrant of the field of view, may be defined based on content, e.g., all automobiles or all red objects, etc. Regional offsets are then established 1438 for the respective regions. For example, one region may have an offset of 3 frames, another an offset of 2 frames, yet another no offset, etc. The feed without offset is directed 1446 to a first eye of a viewer. The regional offsets are applied 1448 to the respective feed regions, and the offset feed is then directed 1450 to the second eye of the viewer.

While the arrangement in FIG. 14 refers only to offsetting regions of one feed (the feed directed to the second eye), in other embodiments it may be suitable to offset regions of both feeds. For example, some features in a left feed could be retarded while others are advanced, while different arrangements of features in a right feed are retarded and/or advanced, to provide specific amounts and/or types of displacements. Embodiments are not limited with regard to what may be offset, or in which feed, or in what manner.

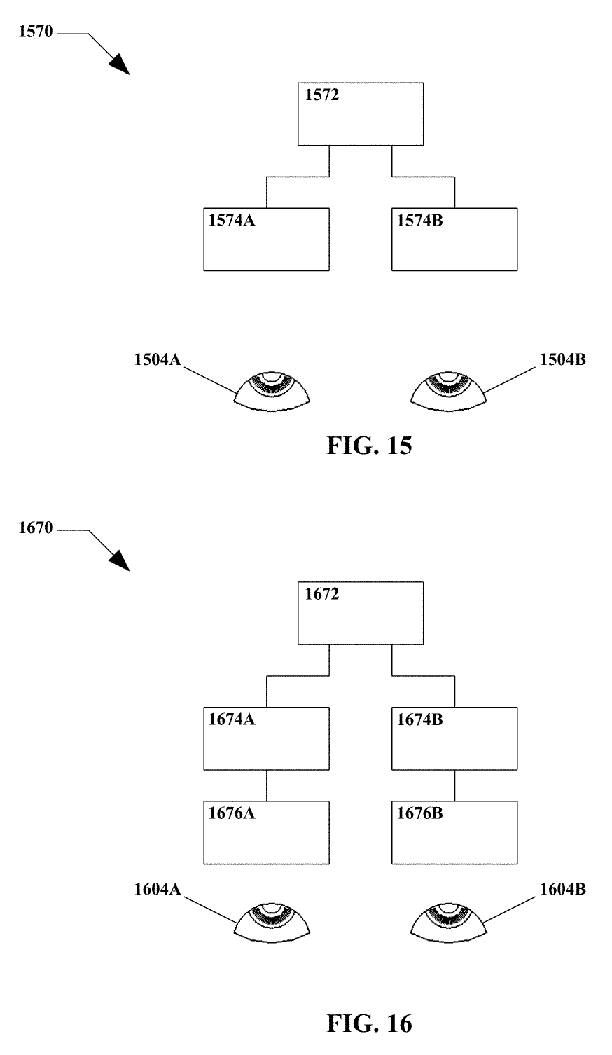

Turning to FIG. 15, therein an apparatus 1570 for providing temporal stereo is illustrated in schematic form. The apparatus 1570 includes a processor 1572. The processor 1572 is adapted to establish a base feed, to establish an offset, to communicate the base feed without the offset to a left display 1574A as a left feed, and to apply the offset to the base feed and communicated that offset to a right display 1574B as a right feed. The left display 1574A then directs the left feed toward a left eye 1520A of a viewer, and the right display 1574B directs the right feed toward a right eye 1520B of the viewer. With suitable left and right feeds (e.g., exhibiting a spatial displacement of at least certain features therebetween due to the offset), the viewer then may visually fuse those left and right feeds so as to be provided with an appearance of depth. Such functions have been previously described herein.

Typically though not necessarily, the processor 1572 may be a digital electronic processor, of a sort as may be found in devices such as smart phones, head mounted displays, laptop computers, etc. Also typically though not necessarily, the processor 1572 may carry out at least certain functions thereof through the execution of executable instructions instantiated onto the processor 1572 (about which more is disclosed subsequently herein). However, the nature of the processor and the manner in which the processor may function are not limited. Furthermore, while a processor 1572 may be a singular and/or well-defined physical entity, in other embodiments groups of processors, cloud computing, etc. also may be suitable.

Displays 1574A and 1574B likewise may vary. Typically though not necessarily, the left and right displays 1574A and 1574B may be digital electronic displays, of a sort as may be found in devices such as smart phones, head mounted displays, laptop computers, etc. Suitable displays may include but are not limited to LEDs, plasma screens, LCDs, CRTs, and electronic paper, though other arrangements may be suitable. In addition, though in certain instances herein the reference is made to left and right displays as distinct entities, in some embodiments it may be suitable for a single physical display to serve as both left and right displays. For example, the screen of a smart phone may define regions as corresponding to a left and right screen, and present left and right feeds respectively thereon.

With reference to FIG. 16, another example apparatus 1670 for providing temporal stereo is illustrated in schematic form. The apparatus 1670 in FIG. 16 may be at least somewhat similar to that in FIG. 15, including a processor 1672 and left and right displays 1674A and 1674B in communication therewith. However, in addition the apparatus 1670 includes left and right optical paths 1676A and 1676B disposed between the left display 1674A and the left eye 1620A of the viewer and between the right display 1674B and the right eye 1620B of the viewer, respectively. The optical paths 1676A and 1676B may include one or more optical elements such as lenses, prisms, mirrors, light pipes, etc. Such optical elements may facilitate directing the left feed from the left display 1676A toward the left eye 1620A, and/or the right feed 1676B toward the right eye 1620B (and/or excluding other content from interfering, e.g., blocking the right feed from reaching the right eye, etc.).

In principle, it may be arguable that an optical path exists between any eye and what that eye may see. Thus, in some sense any apparatus such as that 1672 shown in FIG. 16 may be considered to include optical paths, regardless of whether any lenses, prisms, etc. are present. However for purposes of description, if an optical path is simply “open air”, then there may be no structure to describe with regard to such an optical path. Regardless of definition, certain embodiments such as that shown in FIG. 16 may include optical elements as part of optical paths 1676A and 1676B (though such optical elements are not necessarily required for all embodiments).

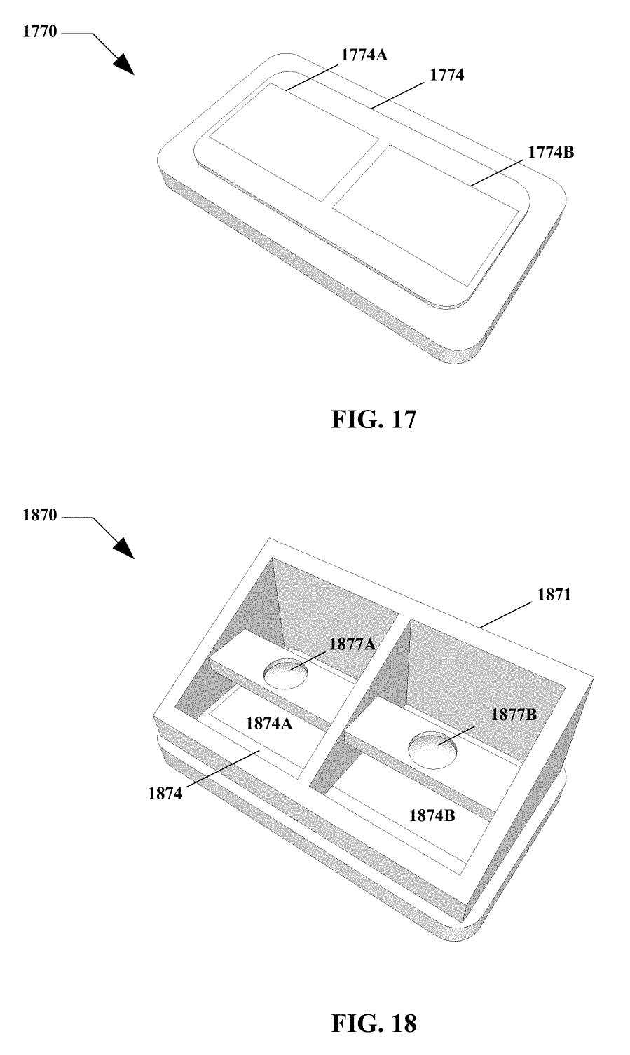

Turning to FIG. 17, an example apparatus 1770 for providing temporal stereo is shown, in perspective view. As may be seen, the apparatus 1770 as shown is in a form as may resemble a smart phone, though this is an example only and is not limiting. The apparatus 1770 includes a display 1774; as noted, that display 1774 may be, and in the arrangement shown in FIG. 17 is, divided logically (though not necessarily physically) into left and right displays 1774A and 1774B. While a processor, etc. may be present within the apparatus 1770, the processor (and other elements as may be present) are not visible externally in the arrangement of FIG. 17.

Again in FIG. 18, another example apparatus 1870 for providing temporal stereo is shown in perspective view. As in the arrangement of FIG. 17, the apparatus 1870 includes a display 1874 logically divided into left and right displays 1874A and 1874B; and, at least a portion of the apparatus 1870 may resemble a smart phone. In addition, the apparatus 1870 includes a frame 1871. As may be seen, the frame 1871 engages with the display 1874, presents a physical barrier dividing the left and right displays 1874A and 1874B, and also supports left and right optical elements 1877A and 1877B. Such optical elements, as noted previously herein, may be part of left and right optical paths directing feeds from the displays 1874A and 1874B to a viewer's eyes. Given the arrangement shown in FIG. 18, a viewer may dispose his or her face in proximity the frame 1871 (or vice versa) for viewing the left and right feeds, fusing those left and right feeds, and viewing the resulting fused scene with the effects of temporal stereo. More colloquially, the arrangement in FIG. 18 may be considered to be a sort of improvised headset, as may be assembled from a smart phone and certain other components (lenses, materials for a frame, etc.).

It is emphasized that the arrangements shown in FIG. 17 and FIG. 18 are not limiting. For example, while a smart phone (or a mechanism visually resembling a smart phone) may be suitable for providing a display, processor, etc. in some embodiments, other embodiments may use other arrangements, and the form and configuration of embodiments is not limited. Other suitable arrangements may include but are not limited to dedicated stereo headsets, as may be suited for gaming, virtual reality, augmented reality, etc.

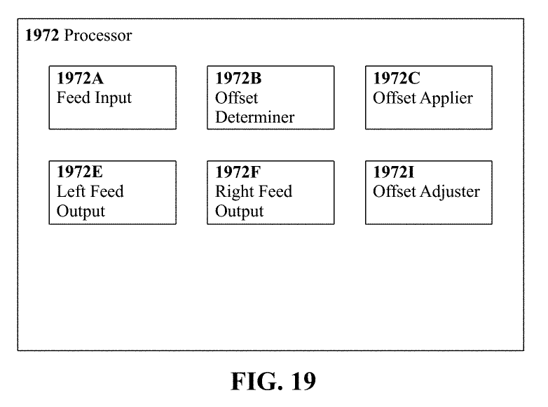

Referring to FIG. 19, a processor 1972 as may be suited for facilitating temporal stereo is shown therein, in schematic form. As has been noted, certain functions may be carried out by a processor 1972 through the use of executable instructions instantiated thereon; FIG. 19 shows several functional blocks of executable instructions 1972A, 1972B, 1972C, 1972E, 1972F, and 1972I disposed on the processor 1972.

More particularly, the feed input 1972A may be adapted to receive, read from storage, generate, or otherwise establish a base feed as input for providing temporal stereo effects. The offset determiner 1972B may be adapted to read, calculate, or otherwise establish an offset to be applied to one of left and right feeds derived from the base feed. The offset applier 1972C may be adapted to apply the offset to the base feed to produce an offset feed, for communication to a display (not shown in FIG. 19). The left feed output 1972E may be adapted to communicate a feed (whether offset or not offset, depending on embodiments and operating particulars) to a left display, and the right feed output 1972F likewise may be adapted to communicate a feed (again whether offset or not offset) to a right display. The offset adjuster 1972I may be adapted to monitor and/or change the amount of offset to be applied based on displacement limits, rates of motion, etc. within the various feeds.

The arrangement of executable instruction blocks 1972A, 1972B, 1972C, 1972E, 1972F, and 1972I is not limiting; other instructions may be present in, and/or instructions shown may be absent from, various embodiments. For example, an embodiment utilizing a fixed offset may not include an offset adjuster 1972I. Likewise, while instructions are shown in instruction blocks 1972A, 1972B, 1972C, 1972E, 1972F, and 1972I, this is illustrative only; in practice executable instructions may be combined together, subdivided, etc.

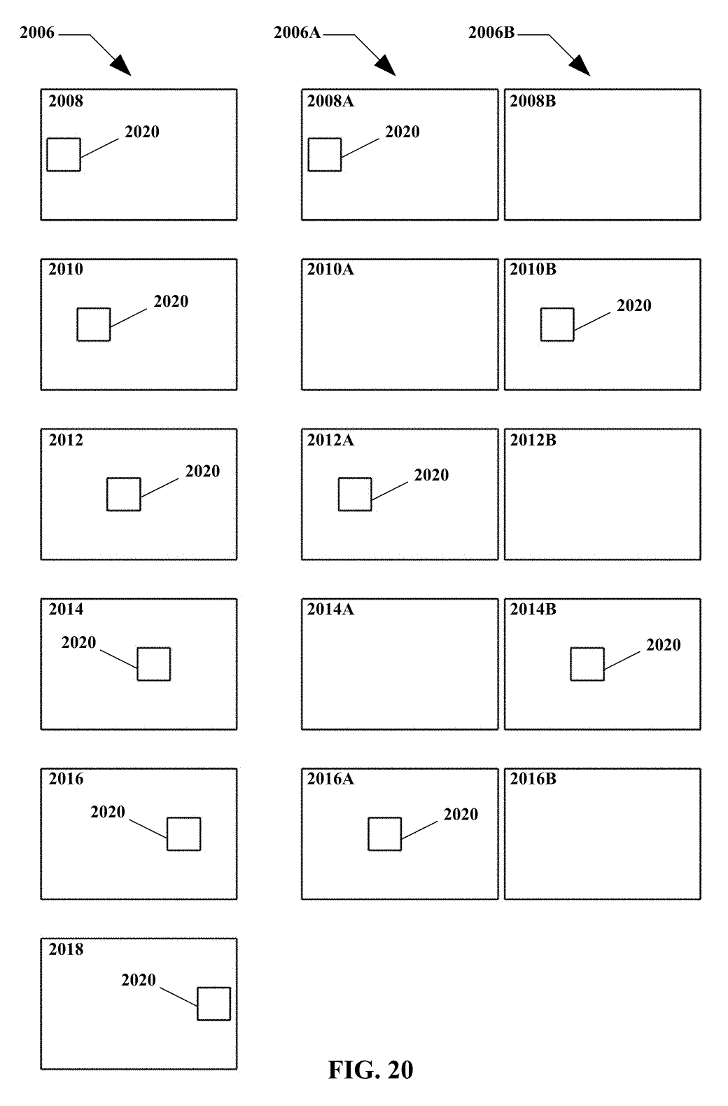

Now with reference to FIG. 20, in certain previous examples herein the left and right feeds provided to a viewer are referred to as distinct from one another. That is, the left feed may be sent through a left display, the right feed through a left display, with little or no “mixing” of content. However, in other embodiments it may be suitable to interlace frames of left and right feeds, and indeed such interlacing may provide certain advantages.

In FIG. 20, three sequences of images are shown, a base feed 2006, a left feed 2006A, and a right feed 2006B. As may be seen, the base feed 2006 includes six frames 2008, 2010, 2012, 2014, 2016, and 2018. Each such frame 2008, 2010, 2012, 2014, 2016, and 2018 shows a target 2020 therein, in the form of a square. Considered sequentially in the order of frames 2008, 2010, 2012, 2014, 2016, and 2018, the base feed 2006 may be interpreted as showing the target 2020 moving horizontally from left to right across the field of view (at least somewhat similarly to FIG. 3).

The left feed 2006A includes five frames 2008A, 2010A, 2012A, 2014A, and 2016A. Two such frames—2010A and 2014A—are blank, for example as if the left feed 2006A were obstructed. The other three frames—2008A, 2012A, and 2016A—are identical (or at least very similar to) base feed frames 2008, 2010, and 2012 respectively. Similarly, the right feed 2006B includes five frames 2008B, 2010B, 2012B, 2014B, and 2016B. Three such frames—2008B, 2012B, and 2016B—are blank, for example as if the right feed 2006A were obstructed. The other two frames—2010B and 2014B—are identical (or at least very similar to) base feed frames 2008 and 2010.

The arrangement shown in FIG. 20 may be understood as an interlacing of left and right feeds 2006A and 2006B, by way of the left and right feeds 2006A and 2006B being obstructed for alternating frames. For example, if the left and right feeds 2006A and 2006B are obstructed in a controllable manner, showing a sequence from the base feed 2006 of frames 2008, 2010, 2010, 2012, 2012, etc. would result in showing frame 2008 to the left eye (as frame 2008A) while the right eye is obstructed, 2010 to the right eye (as frame 2010B) while the left eye is obstructed, 2010 to the left eye (as frame 2012A) as the right eye is obstructed, 2012 to the right eye (as frame 2014B) as the left eye is obstructed, 2012 to the left eye (as frame 2016A) as the right eye is obstructed, etc. Such an arrangement may provide an apparent displacement of the target 2020 as viewed by a viewer fusing left and right feeds 2006A and 2006B.

Presented as a table of frames N through N+4, such an arrangement may be seen as follows:

TABLE 1

| | Frame Passed to | Frame Passed to |
|---|---|---|
| Frame Displayed | Left Eye | Right Eye |
| N | N | (none) |
| N + 1 | (none) | N + 1 |
| N + 1 | N + 1 | (none) |
| N + 2 | (none) | N + 2 |
| N + 2 | N + 2 | (none) |
| N + 3 | (none) | N + 3 |
| N + 3 | N + 3 | (none) |
| N + 4 | (none) | N + 4 |
| N + 4 | N + 4 | (none) |

Such an effect may be achieved for example through the use of so-called “active shutter” or “alternating field” glasses. That is, an image for the left eye is presented via a common display while the right eye is shuttered (e.g., with an LCD shutter on a pair of glasses), then an image for the right eye is presented via the common display while the left eye is shuttered. Human vision tends to merge the left and right images so as to produce a stereo effect. Thus, in such manner a temporal stereo effect may be provided, but through the use of a single common display rather than left and right displays that are personal to an individual.

In addition, as may be observed, for a one frame offset as shown in Table 1, the sequence of frames displayed on such a common screen may be that of the base feed itself: N, N+1, N+2, N+3, N+4, etc. Thus a viewer without active shuttering may view the base feed normally, while viewers with active shuttering may view a temporal stereo effect.

Arrangements for common-display temporal stereo are not necessarily limited only to one-frame offset, however. With an offset of two frames the interleaving effect may be more visible upon examination of frame sequences, and may not result in the base feed being shown on the common feed. For example:

TABLE 2

| Frame No. | Left Eye | Right Eye |
|---|---|---|
| N | N | (none) |
| N + 2 | (none) | N + 2 |
| N + 1 | N + 1 | (none) |
| N + 3 | (none) | N + 3 |
| N + 2 | N + 2 | (none) |
| N + 4 | (none) | N + 4 |
| N + 3 | N + 3 | (none) |
| N + 5 | (none) | N + 5 |
| N + 4 | N + 4 | (none) |

Similarly, an offset of three frames may yield an arrangement as follows:

TABLE 3

| Frame No. | Left Eye | Right Eye |
|---|---|---|
| N | N | (none) |
| N + 3 | (none) | N + 3 |
| N + 1 | N + 1 | (none) |
| N + 4 | (none) | N + 4 |
| N + 2 | N + 2 | (none) |
| N + 5 | (none) | N + 5 |
| N + 3 | N + 3 | (none) |
| N + 6 | (none) | N + 6 |
| N + 4 | N + 4 | (none) |

However, even if a common display is not readily viewable without shuttering for certain offsets, even so a common display may be used while providing individuals only with personal shuttering, without necessarily requiring individuals to be provided with personal left and right displays. In at least some instances, shuttering may be more readily provided than left and right displays.

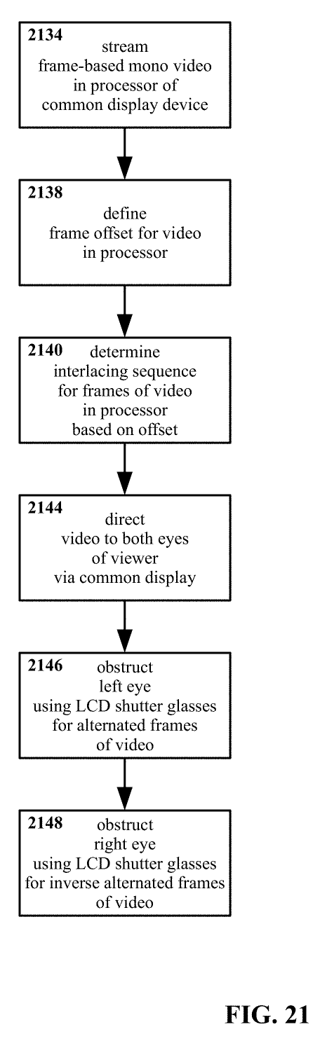

Turning to FIG. 21, an example method for providing an appearance of depth via temporal stereo with a common display is illustrated therein, in flow chart form. The example presented therein is described in relatively specific and concrete form, for clarity of explanation. However, it is again emphasized that the arrangements in FIG. 21 are an example only.

In the example arrangement of FIG. 21, a frame based mono (e.g., two dimensional) video is streamed 2134 in the processor of a common display device, that is, a display device adapted for presenting content to viewers in common (as opposed for example to a personal viewing device such as a head mounted display). As a more concrete example, a desktop computer, laptop computer, tablet, television, movie screen, etc. may serve as a common display. Regardless of the particular device, a frame offset is defined 2138 for the video in a processor. The processor may be integral to the device, for example a processor of a laptop computer, or may be distinct from the display, such as a separate computer controller engaged with a digital video projector in a movie theater. The frame offset may be defined 2138 as some (typically integral) number of frames, e.g., a frame offset of two frames ( 1/24th of a second at 48 fps). Typically though not necessarily, such definition 2138 may be carried out through executable instructions instantiated onto the processor.

The interlacing sequence for frames of the video is determined 2140 in the processor, based on the offset. For example, as shown previously in Table 2 an offset of two frames may be presented as a frame sequence of N, N+2, N+1, N+3, N+2, N+4, N+3, N+5, N+4 . . . . The sequence of frames may vary at least based on the particular offset. Furthermore, if the offset varies during the video, the sequencing may be adjusted, so that a given pattern may not hold true for all frames in the video. The particular sequence is not limited, so long as the functions as described herein may be enabled.

The video stream is directed 2144 to the left and right eyes of a viewer together via the common display. For example, the video frames may be displayed in sequence (as modified by the offset) on a television screen, such that a viewer may view that screen in common with both eyes (though, due to shuttering, perhaps not with both eyes at the same instant). With the video presented by the common screen, the left and right eyes are obstructed 2146 and 2148 using LCD shutter glasses for alternating frames of the video. In such manner, each eye (left and right) sees a sequence of frames as to present a time offset therebetween and thus a spatial displacement therebetween. As visually fused, those left and right sequences of frames may provide an appearance of depth via temporal stereo.

Although the arrangement in FIG. 21 shows each obstruction step 2146 and 2148 only once, as may be understood in practice the left and right eyes may be obstructed 2146 and 2148 in alternating fashion repeatedly, over the course of the video. In addition, while the left eye is shown to be obstructed 2146 first and the right eye obstructed 2148 second, this is an example only, and beginning with the right eye may be equally suitable. Likewise, although the arrangement of FIG. 21 discloses the use of LCD shutter glasses for obstruction 2146 and 2148, this too is an example only, and the particulars of how obstruction may be accomplished (e.g., using what mechanism(s)) are not limited.

Furthermore, as noted with regard to other examples (e.g., FIG. 12), in practice the method may continue after step 2148, may loop back, may include offset adjustment, may include other steps and/or features before, after, or therein, etc.

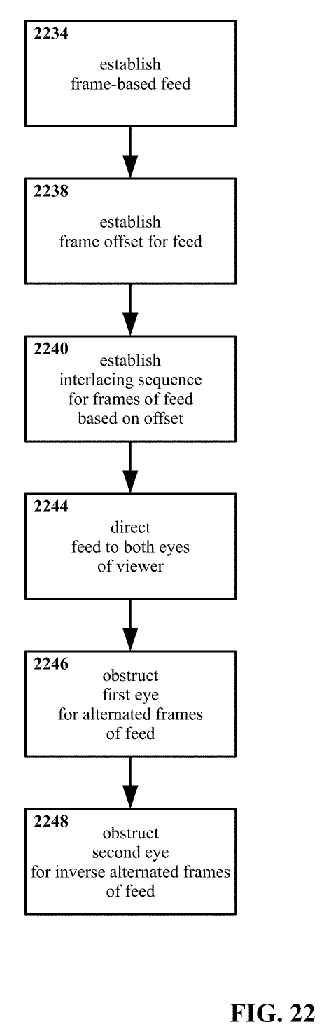

Now with reference to FIG. 22, another example method for providing an appearance of depth via temporal stereo with a common display is illustrated in flow chart form. Where the example of FIG. 21 may be concrete with regard to hardware, feed, etc., the arrangement in FIG. 22 may be understood as less so, so as to suggest a possible range of variations of different embodiments (though not necessarily all such variations).

In FIG. 22, a frame based feed is established 2234, and a frame offset is defined 2238 for the feed. An interlacing sequence for the frames of the feed is established 2240, based at least in part on the offset. The video stream is directed 2244 to both eyes of a viewer, e.g., via a common display. The first and second eyes are obstructed 2246 and 2248 for alternating frames of the feed, such that as visually fused those respective sequences of frames may provide an appearance of depth via temporal stereo.

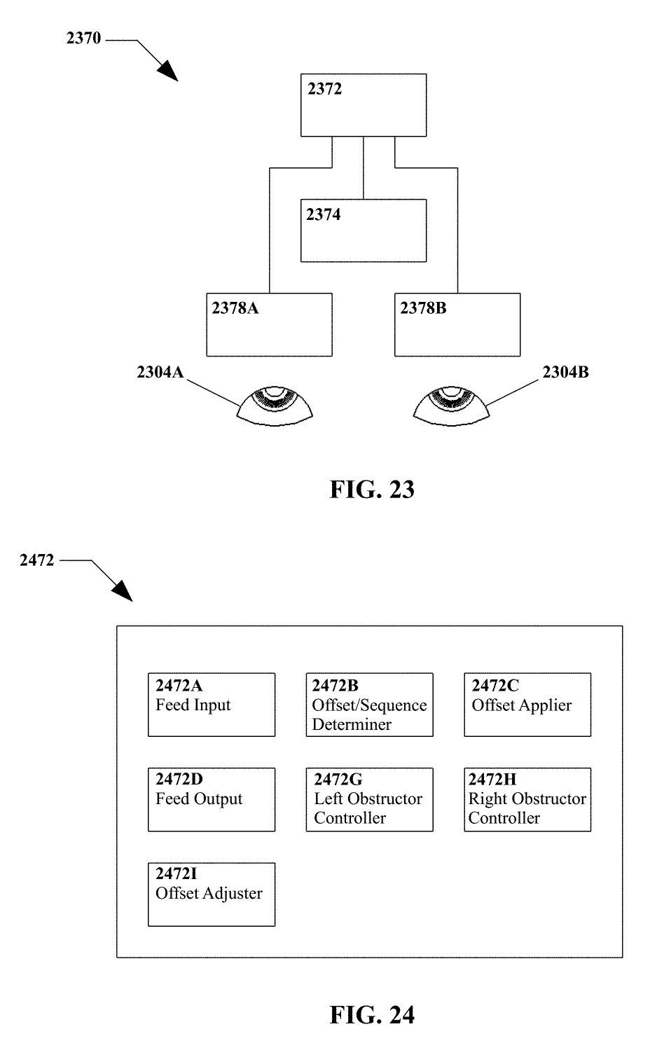

Moving on to FIG. 23, an apparatus 2370 for providing temporal stereo is illustrated in schematic form. The apparatus 2370 includes a processor 2372. The processor 2372 is adapted to establish a feed, to establish an offset, to establish an interlacing sequence for frames of the feed based at least in part on the offset, to direct the feed (as interlaced) to a common display 2374, and to control obstruction of the left and right eyes 2340A and 2340B of the viewer for alternating frames via left and right obstructers 2378A and 2378B. The common display 2374 is adapted to direct the interlaced feed to the left and right eyes 2340A and 2340B of the viewer. The left and right obstructers 2378A and 2378B then alternately block frames of the feed for left and right eyes 2340A and 2340B respectively. With suitable interlacing and obstruction, the viewer then may visually fuse frames viewed by the left and right eyes 2340A and 2340B so as to be provided with an appearance of depth. Such functions have been previously described herein.

Suitable processors 2372 and displays 2374 as may facilitate temporal stereo have already been described herein.

Obstructers 2378A and 2378B may vary considerably from one embodiment to another. So long as the function of obstructing the a viewer's view of the display 2374 with left and right eyes 2304A and 2304B in alternating fashion sufficiently as to enable temporal stereo effects, obstructers 2378A and 2378B may not be otherwise limited. Suitable obstructers may include, but are not limited to, LCD shutters, electrically opaquing films, etc. It is also noted that obstructers 2378A and 2378B may not be required to fully or perfectly block frames in order to provide temporal stereo effects. For example, an LCD shutter may not be 100% opaque, may exhibit gaps or “pinholes” (e.g., due to imperfect LCD coverage), may briefly reveal a frame that is to be obstructed by imperfect timing, etc. So long as such variations are not so severe as to prevent temporal stereo effects, imperfections may be suitable for at least certain embodiments.

It is also noted that, in at least some sense, obstructers 2378A and 2378B may be considered as optical elements along optical paths. Obstructers 2378A and 2378B are referenced uniquely with regard to FIG. 23 as significant functional elements for delivering the feed to the viewer, but in other embodiments it may be suitable to consider obstructers as optical elements, and/or as part of optical paths.

Now with reference to FIG. 24, a processor 2472 as may be suited for facilitating temporal stereo via a common display is shown therein, in schematic form. As has been noted, certain functions may be carried out by a processor 2472 through the use of executable instructions instantiated thereon; FIG. 24 shows several functional blocks of executable instructions 2472A, 2472B, 2472C, 2472D, 2472G, 2472H, and 2472I disposed on the processor 2472.

More particularly, the feed input 2472A may be adapted to receive, read from storage, generate, or otherwise establish a feed as input for providing temporal stereo effects. The offset/sequence determiner 2472B may be adapted to read, calculate, or otherwise establish an offset to be applied to one of left and right feeds derived from the base feed, and/or to determine a sequence of frames for the feed based on the offset (and potentially other factors). The offset applier 2472C may be adapted to apply the offset to the feed to produce a sequenced feed, for communication to a common display. The left and right obstructer controllers 2472H and 2472I may be adapted to control the timing, duration, order, etc., for obstructing a viewer's view with left and right eyes respectively of the feed via the common display. The offset adjuster 2472I may be adapted to monitor and/or change the amount of offset to be applied based on displacement limits, rates of motion, etc. within the various feeds.

The arrangement of executable instruction blocks 2472A, 2472B, 2472C, 2472D, 2472G, 2472H, and 2472I is not limiting; other instructions may be present in, and/or instructions shown may be absent from, various embodiments. Likewise, while instructions are shown in instruction blocks 2472A, 2472B, 2472C, 2472D, 2472G, 2472H, and 2472I, this is illustrative only, and executable instructions may be combined together, subdivided, etc.

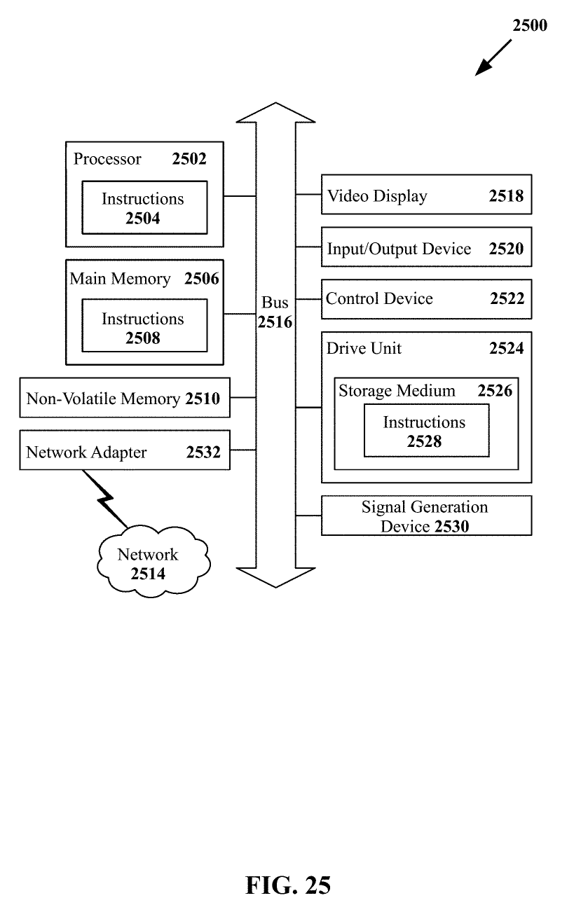

FIG. 25 is a block diagram illustrating an example of a processing system 2500 in which at least some operations described herein can be implemented. The processing system may include one or more central processing units (“processors”) 2502, main memory 2506, non-volatile memory 2510, network adapter 2512 (e.g., network interfaces), video display 2518, input/output devices 2520, control device 2522 (e.g., keyboard and pointing devices), drive unit 2524 including a storage medium 2526, and signal generation device 2530 that are communicatively connected to a bus 2516. The bus 2516 is illustrated as an abstraction that represents any one or more separate physical buses, point to point connections, or both connected by appropriate bridges, adapters, or controllers. The bus 2516, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

In various embodiments, the processing system 2500 operates as a standalone device, although the processing system 2500 may be connected (e.g., wired or wirelessly) to other machines. In a networked deployment, the processing system 2500 may operate in the capacity of a server or a client machine in a client-server network environment, or as a peer machine in a peer-to-peer (or distributed) network environment.

The processing system 2500 may be a server, a personal computer (PC), a tablet computer, a laptop computer, a personal digital assistant (PDA), a mobile phone, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by the processing system.

While the main memory 2506, non-volatile memory 2510, and storage medium 2526 (also called a “machine-readable medium) are shown to be a single medium, the term “machine-readable medium” and “storage medium” should be taken to include a single medium or multiple media (e.g., a centralized or distributed database, and/or associated caches and servers) that store one or more sets of instructions 2528. The term “machine-readable medium” and “storage medium” shall also be taken to include any medium that is capable of storing, encoding, or carrying a set of instructions for execution by the processing system and that cause the processing system to perform any one or more of the methodologies of the presently disclosed embodiments.

In general, the routines executed to implement the embodiments of the disclosure, may be implemented as part of an operating system or a specific application, component, program, object, module or sequence of instructions referred to as “computer programs.” The computer programs typically comprise one or more instructions (e.g., instructions 2504, 2508, 2528) set at various times in various memory and storage devices in a computer, and that, when read and executed by one or more processing units or processors 2502, cause the processing system 2500 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices 2510, floppy and other removable disks, hard disk drives, optical disks (e.g., Compact Disk Read-Only Memory (CD ROMS), Digital Versatile Disks, (DVDs)), and transmission type media such as digital and analog communication links.

The network adapter 2512 enables the processing system 2500 to mediate data in a network 2514 with an entity that is external to the computing device 2500, through any known and/or convenient communications protocol supported by the processing system 2500 and the external entity. The network adapter 2512 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 2512 can include a firewall that can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

As indicated above, the computer-implemented systems introduced here can be implemented by hardware (e.g., programmable circuitry such as microprocessors), software, firmware, or a combination of such forms. For example, some computer-implemented systems may be embodied entirely in special-purpose hardwired (i.e., non-programmable) circuitry. Special-purpose circuitry can be in the form of, for example, application-specific integrated circuits (ASICs), programmable logic devices (PLDs), field-programmable gate arrays (FPGAs), etc.

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

While embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Although the above Detailed Description describes certain embodiments and the best mode contemplated, no matter how detailed the above appears in text, the embodiments can be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

What is claimed is:

1. A method, comprising:
providing a frame-based non-stereo video feed to a processor of a head mounted display, said video feed comprising spatial variation over frames thereof;
defining a frame offset of at least one frame in said processor, said frame offset being a sufficiently large number of frames that said video feed with said frame offset applied thereto exhibits a spatial displacement relative to said video feed without said frame offset applied; and
communicating said video feed without said frame offset applied thereto from said processor to a first display of a stereo display pair of said head mounted display, and
communicating said video feed with said frame offset applied to from said processor to a second display of said stereo display pair, so as to direct said video feed without said frame offset applied thereto to a first eye of a viewer via said first display, and to direct said video feed with said frame offset applied to a second eye of said viewer via said second display, with said spatial displacement exhibited therebetween;
wherein said spatial displacement exhibited between said video feed as directed to said first eye and said video feed as directed to said second eye is fusible via said first and second eyes to manifest an appearance of stereo three dimensionality for said video feed.

2. A method, comprising:
establishing a video feed comprising spatial variation over time;
establishing a time offset, said time offset being sufficiently large that said video feed with said time offset applied thereto exhibits a spatial offset relative to said video feed without said time offset applied; and
directing said video feed without said time offset applied thereto to a first eye of a viewer, and directing said video feed with said time offset applied to a second eye of said viewer, with said spatial exhibited therebetween;
such that said spatial exhibited between said video feed as directed to said first eye and said video feed as directed to said second eye is fusible to manifest an appearance of stereo three dimensionality for said video feed.

3. The method of claim 2, wherein:
said video feed comprises a frame-based video feed, and said time difference offset comprises a frame offset of at least one frame.

4. The method of claim 2, wherein:
said spatial offset extends less than 15 degrees horizontally across a visual field of a said viewer.

5. The method of claim 2, wherein:
said spatial offset extends less than 2 degrees vertically across a visual field of a said viewer.

6. The method of claim 2, comprising:
dynamically varying said time offset.

7. The method of claim 6, comprising:
varying said time offset in response to at least one of a magnitude of said spatial offset, a direction of said spatial offset, and a location of said spatial offset.

8. The method of claim 6, comprising:
varying said time offset toward at least one of a consistent magnitude of said spatial offset over time, a consistent direction of said spatial offset over time, and a specific location of said spatial offset over time.

9. The method of claim 6, comprising:
varying said time offset in real time.

10. The method of claim 6, comprising:
predetermining said time offset for said video feed.

11. The method of claim 6, comprising:
varying said time offset to vary at least one of a magnitude of said spatial offset, a direction of said spatial offset, and a location of said spatial offset.

12. The method of claim 11, comprising:
varying said time offset to vary an apparent depth of said appearance of stereo three dimensionality.

13. The method of claim 2, comprising:
varying said time offset across an area of said video feed.

14. The method of claim 2, comprising:
segmenting at least one visual feature from said video feed and varying said time offset for said visual feature with respect to a remainder of said video feed.

15. The method of claim 2, comprising:
directing said video feed without said time offset applied thereto to said first eye from said first display via a first optical path; and
directing said video feed with said time offset applied thereto to said second eye from said second display via a second optical path.

16. The method of claim 15, comprising:
directing said video feed along said first optical path with at least one first optical element; and
directing said video feed along said second optical path with at least one second optical element.

17. An apparatus, comprising:
a processor;
a stereo display pair comprising first and second displays, in communication with said processor;
executable instructions instantiated on said processor adapted to:
establish a video feed comprising spatial variation over time;
establish a time offset, said time offset being sufficiently large that said video feed with said time offset applied thereto exhibits a spatial displacement relative to said video feed without said time offset applied;
communicate said video feed without said time offset applied thereto to said first display, and communicate said video feed with said time offset applied to said second display, so as to direct said video feed without said time offset applied thereto to a first eye of a viewer via said first display and direct said video feed with said time offset applied to a second eye of said viewer via said second display, with said spatial exhibited therebetween;
wherein said spatial displacement exhibited between said video feed as directed to said first eye and said video feed as directed to said second eye is fusible via said first and second eyes to manifest an appearance of stereo three dimensionality for said video feed.

18. The apparatus of claim 17, comprising:
a unitary physical display; and
said apparatus further comprises executable instructions instantiated on said processor adapted to virtually divide said physical display into said first and second displays of said stereo display pair.

19. The apparatus of claim 17, comprising:
a physical interface adapted to direct said video feed without said time offset applied thereto to said first eye via said first display, and to direct said video feed with said time offset applied thereto to said second eye.

20. The apparatus of claim 19, wherein:
said first display comprises a first portion of said unitary physical display;
said second display comprises a second portion of said unitary physical display;
said physical interface comprises a first director and a second director:
said first director comprising a first optical path, and being adapted to direct said video feed without said time offset applied thereto to said first eye via said first display; and
said second director comprising a second optical path, and being adapted to direct said video feed with said time offset applied thereto to said second eye via said second display.

21. The apparatus of claim 20, wherein:
said first director comprises at least one first optical element; and
said second director comprises at least one second optical element.

22. The apparatus of claim 17, wherein:
said processor and said stereo display pair are disposed in a portable electronic device.

23. The apparatus of claim 19, wherein:
said portable electronic device comprises at least one of a smart phone and a head mounted display.

24. An apparatus, comprising:
means for establishing a video feed comprising spatial variation over time;
means for establishing a time offset, said time offset being sufficiently large that said video feed with said time offset applied thereto exhibits a spatial displacement relative to said video feed without said time offset applied; and
means for communicating said video feed without said time offset applied thereto to a first display of a stereo display pair, and communicating said video feed with said time offset applied to a second display of said stereo display pair, so as to direct said video feed without said time offset applied thereto to a first eye of a viewer via said first display, and to direct said video feed with said time offset applied to a second eye of said viewer via said second display, with said spatial displacement exhibited therebetween;
wherein said spatial displacement exhibited between said video feed as directed to said first eye and said video feed as directed to said second eye is fusible via said first and second eyes to manifest an appearance of stereo three dimensionality for said video feed.
